(19) United States
(12) Patent Application Publication
(10) Pub. No.: US 2010/0190920 A1
(43) Pub. Date: Jul. 29, 2010

(54) CROSSLINKED POLYMERS AND METHODS OF MAKING THE SAME

(76) Inventor: Anuj Bellare, Brighton, MA (US)

Correspondence Address: FISH & RICHARDSON PC, P.O. BOX 1022, MINNEAPOLIS, MN, 55440-1022, US

(21) Appl. No.: 12/527,137

(22) PCT Filed: Feb. 14, 2008
(86) PCT No.: PCT/US08/54034

§ 371 Date: Mar. 5, 2010

Related U.S. Application Data
(60) Provisional application No. 60/889,878, filed on Feb. 14, 2007.
(60) Provisional application No. 60/889,875, filed on Feb. 14, 2007.
(60) Provisional application No. 60/889,880, filed on Feb. 14, 2007.
(60) Provisional application No. 60/977,970, filed on Oct. 5, 2007.

(51) Int. Cl. C08L 23/06; B29C 71/04; B29C 71/02

(52) U.S. Cl. 524/585; 264/488; 264/235

(57) ABSTRACT

Preforms are described, e.g., preforms in rod, sheet or medical device form, that have non-uniform properties in different regions of a single preform. These “engineered preforms” have predetermined properties that can allow, e.g., some regions of a single preform to be relatively stiff and resistant to wear, while other regions of the same preform are relatively flexible. Methods of making the anisotropic preforms are also described.

### TECHNICAL FIELD

This invention relates to crosslinked polymers, methods of making crosslinked polymers, and to uses of the same.

### BACKGROUND

Polymeric materials are used in medical endoprostheses, e.g., orthopaedic implants (e.g., hip replacement prostheses). For example, ultrahigh molecular weight polyethylene (UHMWPE) is used to form components of artificial joints. Desirable characteristics for the polymeric materials used in medical endoprostheses include biocompatibility, a low coefficient of friction, a relatively high surface hardness, and resistance to wear and creep. It is also desirable for such endoprostheses to be readily sterilizable, e.g., by using high-energy radiation, or by utilizing a gaseous sterilant such as ethylene oxide, prior to implantation in a body, e.g., a human body.

High-energy radiation, e.g., in the form of gamma, x-ray, or electron beam radiation, is often a preferable method of sterilization for some endoprostheses, because in addition to sterilizing the endoprostheses, the high energy radiation can sometimes crosslink the polymeric materials, thereby improving the wear resistance of the polymeric materials. However, while treatment of some endoprostheses with high-energy radiation can be beneficial, high-energy radiation can also have deleterious effects on some polymeric components. For example, treatment of polymeric components with high-energy radiation can result in the generation of long-lived, reactive species within the polymeric matrix, e.g., free radicals, radical cations, or reactive multiple bonds, that over time can react with oxygen, e.g., of the atmosphere or dissolved in biological fluids, to produce oxidative degradation in the polymeric materials.

Such degradation can reduce the wear resistance of the polymeric material. Therefore, it is often advantageous to reduce the number of such reactive species. Radiation sterilization of polymeric materials, crosslinking, and entrapment of long-lived, reactive species, and their relationship to wear, crack propagation and other mechanical properties are discussed in Kurtz et al., Biomaterials, 20, 1659-1688 (1999); Tretinnikov et al., Polymer, 39(4), 6115-6120 (1998); Maxwell et al., Polymer, 37(15), 3293-3301 (1996); Kurtz et al., Biomaterials, 27, 24-34 (2006); Wang et al., Tribology International, 31(1-3), 17-33 (1998); Oral et al., Biomaterials, 26, 6657-6663 (2005); Oral et al., Biomaterials, 25, 5515-5522 (2004); Muratoglu et al., Biomaterials, 20, 1463-1470 (1999); Hamilton et al., European Patent Application No. 1072276A1; Li et al., U.S. Pat. No. 5,037,928, NcNulty et al., U.S. Pat. No. 6,245,276; and Muratoglu et al., PCT Publication No. WO 2005/074619. Additional references include U.S. Pat. Nos. 5,414,049, 6,228,900, 6,547,828, 6,464,926, 6,641,617 and 6,786,933; Baker D A, Bellare A and Pruitt L, “The Effect of Degree of Crosslinking on the Fatigue Crack Propagation Resistance of Orthopedic-Grade Polyethylene,” Journal of Biomedical Materials Research (2003) 66A:146-154; Oral E, Wannomae K K, Hawkins N E, Harris W H, Muratoglu O K, “Alpha-Tocopherol Doped Irradiated UHMWPE for High Fatigue Resistance and Low Wear,” Biomaterials (2004) 25(24):5515-5522); and U.S. Published Patent Application Nos. 2005/0043431, 2003/0149125, and 2005/0194722.

### SUMMARY

This invention relates to crosslinked polymers, methods of making crosslinked polymers, and to uses of the same.

In general, preforms are described, e.g., preforms in rod, sheet, or medical device form, that have non-uniform properties in different regions of a single preform. These “engineered preforms” have different regions having predetermined properties, e.g., some regions of a single preform can be relatively stiff and resistant to wear, while other regions of the same preform can be relatively flexible. A preform can have, e.g., 2, 3, 4, 5, 6, or more regions, e.g., 10 regions.

In one aspect, the invention features polymeric preforms that include a first region that includes a first polymeric material having a first antioxidant having a first level of activity dispersed therein, and a second region that includes a second polymeric material having a second antioxidant having a second level of activity higher than the first level of activity dispersed therein. Optionally, the first and second regions define an interface therebetween.

In another aspect, the invention features polymeric preforms that include a matrix that includes a first polymeric material having a first antioxidant having a first level of activity dispersed therein, and a plurality of spaced apart regions within the matrix, each including a second polymeric material having second antioxidant having a second level of activity dispersed therein. In some instances, an interface is defined between each region and the matrix.

In yet another aspect, the invention features polymeric preforms that include a first region that includes a first polymeric material having a first concentration of a first antioxidant dispersed therein and a second region that includes a second polymeric material having a second concentration higher than the first concentration of a second antioxidant dispersed therein. Optionally, an interface defined between by first and second regions.

In still another aspect, the invention features polymeric preforms that include a first crosslinked region that includes a first crosslinked polymeric material having a first average crosslink density and a second crosslinked region that includes a second crosslinked polymeric material having a second average crosslink density higher than the first average crosslink density. Optionally, an interface is defined between the first and second regions.

In a further aspect, the invention features methods of making composite preforms that include selecting a first preform that includes a first substantially non-crosslinked polymeric material having a first concentration of a first antioxidant dispersed therein; selecting a second preform that includes a second substantially non-crosslinked polymeric material having a second concentration higher than the first concentration of a second antioxidant dispersed therein; and fusing the first and second preforms to provide a composite preform having a first region and a second region corresponding to the first and second preforms, respectively, which together define an interface therebetween.

In one aspect, the invention features methods of making preforms that include selecting a filled preform that includes a substantially non-crosslinked polymeric material having an antioxidant dispersed therein at an average first concentration; and reducing the concentration of the antioxidant from one or more selected regions of the filled preform to provide a heterogeneous preform having one or more regions having an average second concentration of the antioxidant which is less than the first average concentration.

In another aspect, the invention features polymeric preforms that include a matrix that includes a first polymeric material having a first concentration of a first antioxidant dispersed therein, and a plurality of spaced apart regions within the matrix that include a second polymeric material having a second concentration different from the first concentration of a second antioxidant dispersed therein; and an interface defined between each region and the matrix.

In still another aspect, the invention features methods of making preforms that include combining a substantially non-crosslinked polymeric material with a solid antioxidant at a temperature below a melting point and/or solidification point of the solid antioxidant to provide a molding compound; and molding the molding compound at a temperature above a melting point and/or solidification point of the solid antioxidant in a desired shape to provide a composite preform having regions which are relatively enriched in the antioxidant and regions which are relatively depleted of the antioxidant.

In yet another aspect, the invention features methods of making preforms that include selecting a filled preform that includes a substantially non-crosslinked polymeric material having an antioxidant dispersed therein; infusing a liquid material into the filled preform that is a solvent for the antioxidant at about room temperature, and is a poor solvent or non-solvent for the antioxidant about a melting point of the liquid material; cooling the infused liquid preform below a solidification point of the antioxidant in the liquid material; and removing some of the liquid material from the cooled, liquid infused preform to provide a composite preform having first regions that are relatively enriched in the antioxidant and second regions that are relatively depleted of the antioxidant.

In a further aspect, the invention features polymeric preforms that include a matrix that includes a first crosslinked polymeric material having a first average cross link density, and a plurality of spaced apart regions that include a second crosslinked polymeric material having a second average cross link density different from the first average cross link density. Optionally, an interface is defined between each spaced apart region and matrix, e.g., a sharp or diffuse interface.

In one aspect, the invention features methods of making preforms that include combining a first substantially non-crosslinked polymeric material with a first antioxidant to provide a first molding compound having a first concentration of the first antioxidant in the first molding compound; combining a second substantially non-crosslinked polymeric material with a second antioxidant to provide a second molding compound having second concentration of the second antioxidant higher than the first antioxidant in the first molding compound; combining the first molding compound and the second molding compound to provide a composite molding compound; and molding the composite molding compound in a desired shape to provide a composite preform.

In another aspect, the invention features methods of making preforms that include selecting a filled preform that includes a substantially non-cross linked polymeric material having an antioxidant dispersed therein; infusing a first liquid material into the filled preform that is a solvent for the antioxidant to provide a solvent infused preform; infusing a second liquid material into the solvent infused preform that is a non-solvent for the antioxidant, but miscible with the first solvent to cause solidification of the antioxidant to provide a preform having solid particles of antioxidant dispersed therein; and removing some of the first or second liquid material to provide a composite preform having first regions that are relatively enriched in the antioxidant and second regions that are relatively depleted of the antioxidant. For example, the antioxidant can be solidified by cooling.

In still another aspect, the invention features methods of making preforms that include selecting a filled preform that includes a substantially non-cross linked polymeric material having an antioxidant dispersed therein; infusing a first liquid material into the filled preform that is a solvent for the antioxidant to provide a solvent infused preform; infusing a second liquid material into the solvent infused preform that is a non-solvent for the antioxidant, but miscible with the first solvent to cause solidification of the antioxidant to provide a preform having solid particles of antioxidant dispersed therein; removing some of the first or second liquid material to provide a composite preform having regions which are relatively enriched in the antioxidant and regions which are relatively depleted of the antioxidant; cooling the composite preform to a temperature above a glass transition temperature of the substantially non-crosslinked polymeric material to provide a cooled preform; and crosslinking the cooled, infused preform to provide a crosslinked preform.

In yet another aspect, the invention features methods of making preforms that include infusing an antioxidant into a preform that includes a substantially non-crosslinked polymeric material to provide an antioxidant infused preform; cooling the antioxidant infused preform to a temperature above a glass transition temperature of the substantially non-crosslinked polymeric material to provide a cooled, infused preform; and crosslinking the cooled, infused preform to provide a crosslinked preform.

In one aspect, the invention features methods of making preforms that include combining a first substantially non-crosslinked polymeric material with a first antioxidant to provide a first molding compound having a first concentration of the first antioxidant in the first molding compound; combining a second substantially non-crosslinked polymeric material with a second antioxidant to provide a second molding compound having second concentration of the second antioxidant higher than the first in the first molding compound; combining the first molding and the second molding compound to provide a composite molding compound; molding the composite molding compound in a desired shape to provide a composite preform; cooling the composite preform to a temperature above a glass transition temperature of the first and/or second substantially non-cross linked polymeric material to provide a cooled preform; and crosslinking the cooled, infused preform to provide a crosslinked preform.

In another aspect, the invention features methods of making preforms that include combining a substantially non-crosslinked polymeric material with a solid antioxidant at a temperature below a melting point and/or a solidification point of the solid antioxidant to provide a molding compound; molding the molding compound at a temperature above a melting and/or solidification point of the solid antioxidant in a desired shape to provide a composite preform having regions which are relatively enriched in said antioxidant and regions which are relatively depleted of said antioxidant; cooling the composite preform to a temperature above a glass transition temperature of the substantially non-crosslinked polymeric material to provide a cooled preform; and crosslinking the cooled, infused preform to provide a crosslinked preform.

In still another aspect, the invention features methods of making preforms that include selecting a filled preform that includes a substantially non-cross linked polymeric material having an antioxidant dispersed therein; infusing a liquid material into the filled preform that is a solvent for the antioxidant at about room temperature, but a poor or non-solvent for the antioxidant about a melting point of the liquid material; cooling the infused liquid preform below a solidification point of the antioxidant in the liquid material; removing some of the liquid material from the cooled, liquid infused preform to provide a composite preform having regions which are relatively enriched in the antioxidant and regions which are relatively depleted of the antioxidant; cooling the composite preform to a temperature above a glass transition temperature of the substantially non-cross linked polymeric material to provide a cooled preform; and crosslinking the cooled, infused preform to provide a crosslinked preform.

In yet another aspect, the invention features a method of making a composite preform. The method includes selecting a first preform including a first substantially non-crosslinked polymeric material, the first polymeric material having a first average concentration (e.g., a concentration over a given volume such as 1 cm³, 50 cm³, or 100 cm³ of a preform) of a first antioxidant dispersed therein; selecting a second preform including a second substantially non-crosslinked polymeric material, the second polymeric material having a second average concentration of a second antioxidant dispersed therein; and fusing the first and second preforms to provide a composite preform having a first region and a second region corresponding to the first and second preforms, respectively, which together define an interface therebetween.

Embodiments may have one or more of the following features. In some embodiments, the first and second antioxidants can be uniformly distributed and/or non-uniformly distributed within the first and second preforms. The first and the second antioxidants can be the same and the first and second levels can be the result of a first and a second concentration (e.g., average concentration) of the antioxidant. In some embodiments, the first and second average concentrations of the antioxidants can be the same. The first antioxidant and/or the second antioxidant can include more than a single compound, e.g., one or more phenolic compounds, such as alpha-tocopherol, BHT, DL-alpha-tocopheryl acetate, and (+)-alpha-tocopherol acid succinate. The first and second antioxidants can be the same. The first and/or second antioxidants can include between about 0.01 percent by weight to about 20 percent by weight (e.g., between about 0.1 to about 1 percent by weight) of their respective regions. In some embodiments, the first concentration can be higher than the second concentration. In some embodiments, the first concentration is zero. The first and/or second antioxidant can have a nominal melting point above about room temperature, e.g., above about 50° C. A molecular weight of the first and/or second antioxidant can be above about 400 g/mole.

The first polymeric material can include a substantially non-crosslinked polymeric material and/or a crosslinked material. The second polymeric material can include a substantially non-crosslinked polymeric material and/or a crosslinked material. The first and second polymeric materials can be the same polymeric material. The first and the second polymeric materials can each be a polyolefin, such as a UHMWPE.

The ultra-high molecular weight polyethylene (UHMWPE) can have a crosslink density of greater than about 50 mol/m³ (e.g., greater than about 80 mol/m³, or greater than about 100 mol/m³). In some embodiments, the UHMWPE can have a molecular weight between crosslinks of less than about 9,000 g/mol.

The preform can have a longitudinal length, and the first and second regions can run along the entire longitudinal length of the preform. The polymeric preform can include one or more antioxidants dispersed therein, or be substantially free of antioxidants. The interface can be a sharp interface, e.g., characterized in that a transition from the first average crosslink density to the second average crosslink density occurs within a distance of about 0.05 mm or less, or a diffuse interface, e.g., characterized in that a transition from the first density to the second density occurs within a distance of about 1 mm or less. The substantially non-crosslinked preform and/or the crosslinked preform can be in rod form. The substantially non-crosslinked preform and/or the crosslinked preform can be in the form of a medical device or portion thereof.

The first and/or second preform can be formed, e.g., by infusing the first and/or second respective antioxidant, and/or by combining the first and/or second respective antioxidant with the first and/or second substantially non-crosslinked polymeric material to provide molding compounds, followed by molding the molding compounds to provide the first and/or second preform.

Crosslinking can be performed by irradiation with an ionizing radiation. The methods can further include crosslinking the composite preform, such as by irradiating the composite preform (e.g., with an ionizing radiation, such as gamma radiation or e-beam radiation) to provide a crosslinked composite. In some embodiments, the methods include cooling the composite preform, and, optionally, storing the preform for a desired amount of time; and then irradiating the composite preform. In some embodiments, the antioxidant has one or more melting points and/or solidification points, and an antioxidant infused preform is cooled to below a melting point and/or a solidification point of the antioxidant. In some embodiments, the methods further include annealing the irradiated (e.g., crosslinked) composite preform.

The annealing can be performed below a melting point of the polymeric material of the preform and/or in the presence of a quenching material. The annealing can include heating the crosslinked preform below a melting point of the crosslinked polymeric material. For example, the annealing can include heating the crosslinked preform between about 100° C. and about 1° C. (e.g., between about 25° C. to about 0.5° C.) below a melting point of the crosslinked polymeric material. The annealing can include applying a pressure above nominal atmospheric pressure (e.g., greater than 10 MPa) to the crosslinked polymeric material, while heating the crosslinked material to a temperature below a melting point of the crosslinked polymeric material at the applied pressure for a time sufficient to provide an oxidation resistant crosslinked polymeric material. The applied pressure can be greater than 350 MPa.

Annealing can be carried out in the presence of a reactive gas that can quench residual reactive species trapped in the crosslinked polymeric material. The reactive gas can include one or more unsaturated compounds, such as acetylene.

Methods described herein can include removing substantially all antioxidants prior to irradiating or annealing.

The filled preform can be prepared by infusing the antioxidant into a non-filled preform, and, optionally annealing the infused preform to uniformly disperse the antioxidant. The concentration of the antioxidant in one or more selected regions of the filled preform can be reduced by leaching the preform in a solvent. The infusion and/or leaching can be performed using a solvent and/or a supercritical gas, for example, an alcohol such as ethanol, or a supercritical fluid such as supercritical carbon dioxide.

A filled preform can be prepared by combining the substantially non-crosslinked polymeric with the antioxidant to provide a molding material; and then molding the molding material into a desired shape. The methods can further include irradiating the preform (e.g., a leached preform) with a beam of electrons or gamma radiation to provide an irradiated and/or crosslinked preform. The methods can include replacing the leached antioxidant with one or more antioxidants that are the same or different as the antioxidant that was leached. The methods can include cooling the leached preform; and, optionally, storing the preform for a desired amount of time; and then irradiating the leached preform. The liquid infused preform can be cooled to above a melting point of the liquid material, or to below a melting point of the liquid material (e.g., solvent).

In some embodiments, the spaced apart regions are discrete and/or can be approximately circular in cross-section. In some embodiments, the spaced apart regions are not discrete (e.g., interconnected).

In some embodiments, the first substantially non-crosslinked polymeric material can be combined with the first antioxidant with the aid of a solvent. The solvent (e.g., liquid material) can include an alcohol (e.g., ethanol) and/or a supercritical fluid (e.g., carbon dioxide). Solvent can be removed by applying a vacuum. The solidified liquid material can be removed by freeze-drying.

Embodiments can have any one of, or combinations of, the following advantages. The preforms, e.g., preforms in rod, sheet or medical device form, can have anisotropic properties, e.g., they can have non-uniform properties in different regions of a single preform. For example, preforms having different regions having predetermined properties are provided that allow for relatively stiff and resistant to wear regions in combination with relatively flexible regions. The crosslinked materials are stable over extended periods of time and are resistant to oxidation. The crosslinked polymeric materials are highly crystalline, e.g., having a crystallinity of greater than 54 percent, e.g., 57 percent or higher. Crosslinked regions of preforms can be highly crosslinked, e.g., having a high crosslink density, and/or a relatively low molecular weight between crosslinks. Parts formed from the anisotropic materials can have regions that have high wear resistance, enhanced stiffness, as reflected in flexural and tensile moduli, a high level of fatigue and crack propagation resistance, and enhanced creep resistance. Some of the regions can have a low coefficient of friction. In addition, the described methods are easy to implement.

An “antioxidant” is a material, e.g., a single compound or polymeric material, or a mixture of compounds or polymeric materials, that reduce the rate of oxidation reactions.

A second antioxidant has a higher level of activity than a first antioxidant if it retards crosslinking more than the first antioxidant, measured when both antioxidants are infused into an UHMWPE preform at the same concentrations and crosslinked under the same conditions. Retardation of crosslinking can be determined by measuring crosslink density.

An “oxidation resistant crosslinked polymeric material” is one that loses less than 25 percent of its elongation at break (ASTM D412, Die C, 2 hours, and 23° C.) after treatment in a bomb reactor filled with substantially pure oxygen gas to a pressure of 5 atmospheres, heated to 70° C. temperature, and held at this temperature for a period of two weeks.

A “substantially non-crosslinked polymeric material” is one that is melt processible, or in the alternative, dissolves in a solvent, whereas a “substantially crosslinked polymeric material” is one that is not melt processible, or in the alternative, one that does not dissolve in any solvent, although it may swell.

To “fuse” two polymeric materials is to apply pressure, and, optionally heat, to bond the two material together.

A “supercritical fluid” is any substance at a temperature and a pressure above its thermodynamic critical point.

A polymeric preform that is “filled” is one that includes another material, e.g., an antioxidant, substantially homogeneously dispersed therein.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

FIG. 1 shows cross-sectional views of preforms (e.g., acetabular in form); the preform on the left (preform 1) includes a first region having a first level of antioxidant and a second region having a second level of antioxidant; while the preform on the right (P2) is the one on the left after annealing to homogenize the antioxidant level in the preform.

FIG. 2 is a cross-sectional view of a preform (e.g., acetabular in form) that includes a first region having a first level of crosslinking and a second region having a second level of crosslinking.

FIG. 3 shows exemplary structures for several antioxidants.

FIG. 4 shows cross-sectional views of preforms (e.g., tibial in form); on the bottom the preforms (P3-5) being fused together to provide a composite preform shown on the left (P6), which includes a first and a third region having a first level of antioxidant and a second region sandwiched between the first and third regions having a second level of antioxidant; while the preform on the right (P7) is the one on the left after annealing to homogenize the antioxidant level in the preform.

FIG. 5 is a cross-sectional view of a preform that includes a first and a third region having a first level of crosslinking, and a second region sandwiched between the first and third regions that has a second level of crosslinking.

FIG. 6 shows cross-sectional views of preforms; the preform on the right (P8) includes a matrix that includes a first level of antioxidant and a plurality of spaced apart regions within the matrix that each include a second level of antioxidant; while the preform on the right (P9) is the one on the left after annealing to homogenize the antioxidant level in the preform.

FIG. 7 is a cross-sectional view of preform that includes matrix that includes a first level of crosslinking and a plurality of spaced apart regions within the matrix, each having a second level of crosslinking.

FIG. 8A is a perspective, cut-away view of a gamma irradiator.

FIG. 8B is an enlarged perspective view of region 8B of FIG. 8A.

FIG. 9 is a schematic perspective view of a cylindrical plug cut from an extruded rod made from substantially non-crosslinked ultrahigh molecular weight polyethylene (UHMWPE).

FIG. 10 is a cross-sectional view of a crosslinked UHMWPE rod in a mold disposed within a furnace.

FIG. 11 is a partial cross-sectional view of a hip prosthesis having a bearing formed from crosslinked UHMWPE.

FIG. 12 is a schematic representation of a tibial insert or a tibial plateau including UHMWPE having a uniform concentration of vitamin E and irradiated using low powered electron beam with certain masked regions.

FIG. 13 is a schematic representation of an acetabular cup including UHMWPE having a uniform concentration of vitamin E and irradiated using low powered electron beam with certain masked regions.

FIG. 14A is a photograph of a homogenous solution containing vitamin E dissolved in ethanol at room temperature, while FIG. 14B is the same solution as that shown in FIG. 14A after cooling overnight at −80° C.

FIG. 15 is a photograph of a Styrofoam container housing polyethylene specimens that contain vitamin E.

FIG. 16 is a Transvinylene Index (TVI) versus depth profile for a UHMWPE containing Vitamin E after irradiation to a dose of 100 kGy using 2.8 MeV electron beam.

FIG. 17 is a photograph of a UHMWPE article in which a UHMWPE sheet without Vitamin E is fused to a UHMWPE containing 0.1% Vitamin E creating a non-uniform Vitamin E distribution in a direction orthogonal to the direction of radiation.

FIG. 18 is a photograph of a UHMWPE article in which a UHMWPE sheet without Vitamin E is fused to a UHMWPE containing 0.1% Vitamin E creating a non-uniform Vitamin E distribution in a direction parallel to the direction of radiation.

FIG. 19 is a photograph of two specimens, one before diffusion of Vitamin E from the Vitamin E-rich region into the Vitamin E poor region (left) and the second specimen where some Vitamin E has diffused through the sharp interface into the Vitamin E-poor region after annealing at 130° C. for a period of 24 hours.

FIG. 20 shows depth profiles of alpha-tocopherol index obtained from FTIR spectra showing the alpha-tocopherol index profile before diffusion (circles) and diffusion profile (triangles) of Vitamin E from the Vitamin E—rich region into the Vitamin E-poor region of UHMWPE after 24 hours of annealing at 130° C. (dashed line represents interface).

FIG. 21 is a schematic representation showing the regions and directions in the UHMWPE where FTIR spectra was collected in FIGS. 22, 23 and 24.

FIG. 22 is a Transvinylene Index (TVI) versus depth profile for a UHMWPE containing Vitamin E after irradiation to a dose of 100 kGy using 2.8 MeV electron beam.

FIG. 23 is a Transvinylene Index (TVI) versus depth profile for a UHMWPE containing Vitamin E under a 1/16″ Aluminum mask after irradiation to a dose of 100 kGy using 2.8 MeV electron beam.

FIG. 24 is a Transvinylene Index (TVI) versus transverse depth profile for a UHMWPE containing Vitamin E after irradiation to a dose of 100 kGy using 2.8 MeV electron beam.

### DETAILED DESCRIPTION

Described herein are preforms, e.g., preforms in rod, sheet, or medical device form, that have non-uniform properties in different regions of a single preform. These “engineered preforms” having different regions having predetermined properties can allow, e.g., some regions of a single preform to be relatively stiff and resistant to wear, while other regions of the same preform are relatively flexible. For example, when the preforms are used in medical devices such as a prostheses, high, wear-resistant levels of crosslinking can be provided on articular surfaces of preforms that are in sliding contact with other ceramic and/or metallic components, while lower levels of crosslinking can be provided to interior regions, giving those regions, e.g., higher fatigue life and ultimate tensile stress and elongation in comparison to the articular regions. In some methods described herein, the ability of some antioxidants to suppress crosslinking is utilized to induce spatial variations in crosslinking throughout a material. For example, having preform having a relatively low level of antioxidant (or simply no antioxidant) in near surface regions and a relatively high level of the same or another antioxidant in other regions, provides for a higher level of crosslinking in the near surface region when such a preform is crosslinked, e.g., by irradiation with gamma radiation. In other methods, temperature is used to control reaction rate and/or diffusion rate of antioxidants within a polymeric material. In still other methods, temperature is used to solidify and/or crystallize antioxidants, effectively sequestering the antioxidants within a polymeric material for a predetermined time.

Preforms and General Methodology

Generally, in some embodiments, the methods described herein provide polymeric preforms, e.g., in sheet form, bar form, rod form or in the form of a medical device, such as an implant, that include a first region that includes a first polymeric material having a first antioxidant having a first level of activity dispersed therein, and a second region that includes a second polymeric material having a second antioxidant having a second level of activity higher than the first level of activity dispersed therein. Optionally, the first and second regions define an interface therebetween. Upon crosslinking, e.g., by the application of radiation, e.g., ionizing radiation, such as gamma radiation or electron beam radiation, two regions are formed, each having a crosslinking degree that corresponds to the level of antioxidant in the region.

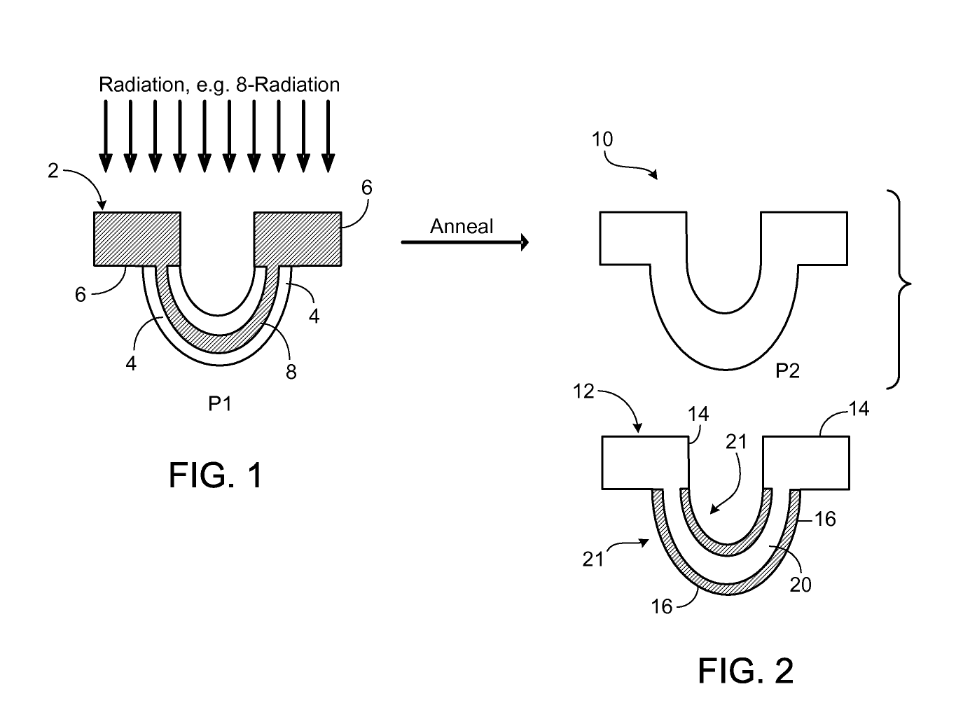

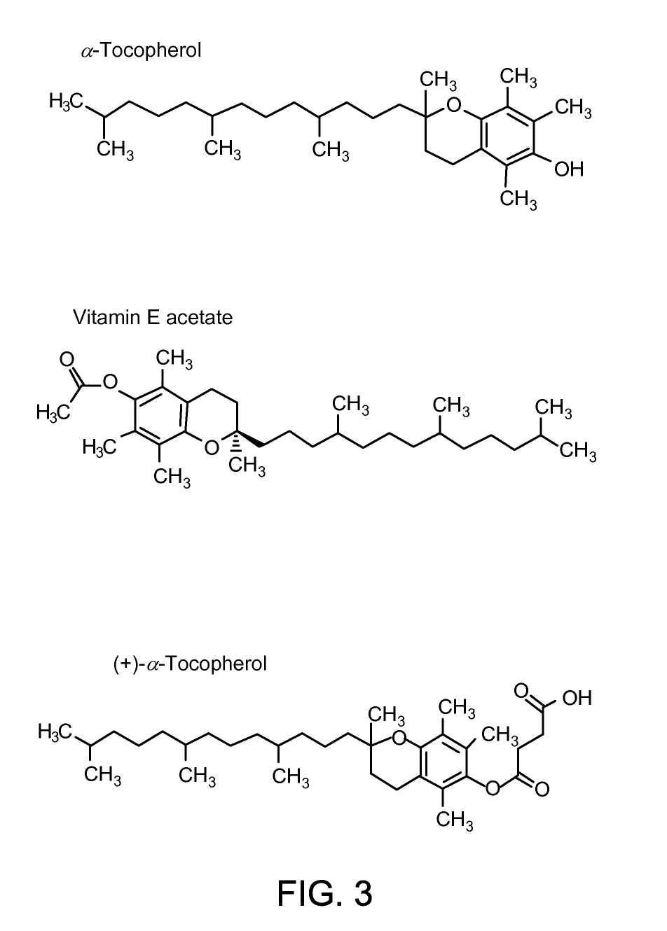

Referring to FIG. 1, a composite polymeric preform 2 in the form of an acetabular component includes a first region 4 that includes a first polymeric material having a first concentration of a first antioxidant dispersed therein and a second region 6 that includes a second polymeric material having a second concentration higher than the first concentration of a second antioxidant dispersed therein. The first and second regions together define an interface 8. In some embodiments, the first antioxidant and the second antioxidants are the same. For example, the antioxidant can be alpha-tocopherol (vitamin E), vitamin E acetate and/or (+)-alpha-tocopherol acid succinate (see FIG. 3 for corresponding structures).

In some embodiments, the first and the second polymeric materials are each the same polymeric material, e.g., a polyolefin, such as a ultra-high molecular weight polyethylene (UHMWPE).

In some embodiments, the preform has a longitudinal length and each of the first and second regions run along the entire longitudinal length of the preform.

In some implementations, the first and/or second antioxidants are present in amounts of between about 0.01 percent by weight to about 20 percent by weight of their respective regions, e.g., between about the 0.1 to about 10 percent or between about 0.4 percent and about 5 percent by weight of their respective regions.

In some implementations, the first concentration is zero.

Preform 2 can be crosslinked, e.g., by gamma radiation, and then annealed, e.g., by heating with the application of pressure at a temperature below a melting point of the polymeric material of preform 2. In some embodiments, annealing allows for a homogenous distribution of the antioxidant because at elevated temperatures the antioxidant can diffuse throughout the preform, as shown by the uniform shading of preform 10. In embodiments when both the first and the second antioxidants are the same, after crosslinking regions that had the higher concentration of antioxidant have a lower level of crosslinking than do those regions that have a lower level of antioxidant because the antioxidant retards crosslinking.

Referring to FIG. 2, a crosslinked preform 12 in the form of an acetabular component includes a first crosslinked region 14 that includes a first crosslinked polymeric material having a first average crosslink density, and a second crosslinked region 16 that includes a second crosslinked polymeric material having a second average crosslink density higher than the first average crosslink density. An interface 20 is defined between the first and second regions. In the preform shown, contact surfaces 21 generally have a higher wear resistance than the inner portions of the acetabular component because they are more highly crosslinked. On the other hand, the inner portions of the acetabular component have a greater degree of flexibility and can generally better decrease the likelihood of crack propagation than outer portions.

In some embodiments, the first crosslinked polymeric material comprises an ultra-high molecular weight polyethylene (UHMWPE) having a crosslink density of greater than about 100 mol/m³ and/or the second polymeric material comprises an ultra-high molecular weight polyethylene (UHMWPE) having a molecular weight between crosslinks of less than about 9,000 g/mol.

Preform 12 can have a sharp interface, e.g., characterized in that a transition from the first average crosslink density to the second average crosslink density occurs within a distance of about 0.05 mm or less, or a diffuse interface, e.g., characterized in that a transition from the first density to the second density occurs within a distance of about 1 mm or less.

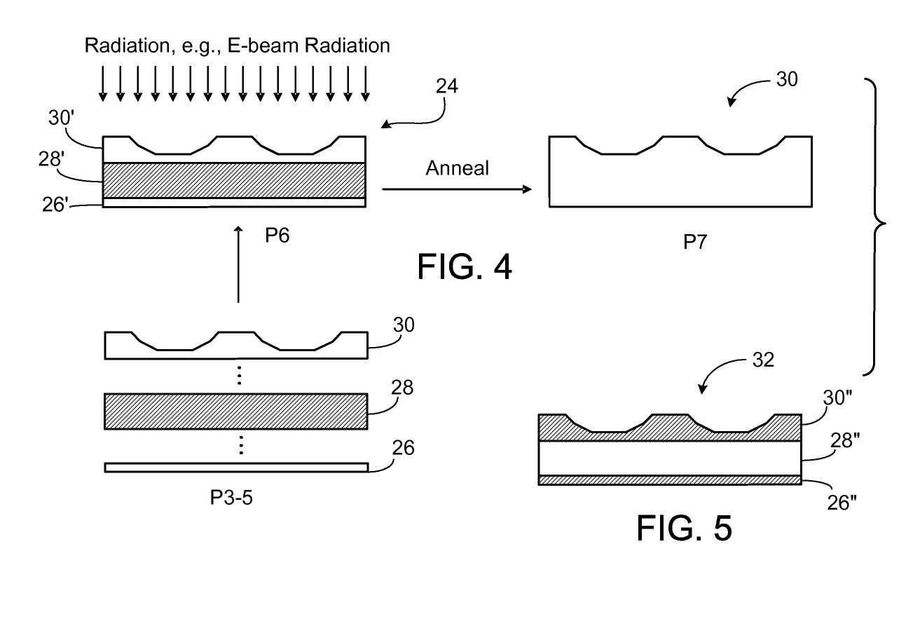

Referring now to FIG. 4, in some embodiments a composite preform in the form of a tibial component 24 is made by selecting a first preform 26 that includes a first substantially non-crosslinked polymeric material having a first concentration of a first antioxidant dispersed therein, selecting a third preform 30 that includes a first substantially non-crosslinked polymeric material having a first concentration of a first antioxidant dispersed therein and selecting a second preform 28 that includes a second substantially non-crosslinked polymeric material having a second concentration higher than the first concentration of a second antioxidant dispersed therein. The first, second and third preforms are assembled by fusing the first, second and third preforms, e.g., by using heat and pressure to provide preform 24. Preform 24 includes first 26′ and third 30′ and middle regions 28′, corresponding to preforms 26, 30 and 28, respectively. An interface is defined region 26′ and 28′ and 28′ and 30′. As shown in FIG. 4, preform 24 can be crosslinked, followed by annealing to homogenously distribute the antioxidant(s) to provide preform 30.

Preform 24 can be prepared by selecting solid preforms having the same shape as preforms 26, 28 and 30, but that do not have any antioxidant therein, and then infusing the preforms with the desired antioxidant at the desired level. Preform 24 can then be provided by fusing the components.

Preform 24 can also be prepared by molding polymeric powders to shapes corresponding to preforms 26, 28 and 30. The powders would include a desired antioxidant at a desired level. Preform 24 can then be provided by fusing the components. In other embodiments, the preform 24 is provided by co-molding the powders.

In some embodiments, the first and/or second antioxidant has a nominal melting point above about room temperature, e.g., above about 50° C. Having a relatively high melting point can help to prevent diffusing of the antioxidant into other regions during formation of composite preforms.

In some embodiments, the first and/or second antioxidant is above about 400 g/mole, e.g., above about 500, about 1,000 g/mole. In some embodiments, the antioxidant is polymeric, e.g., having a molecular weight above about 2,500, e.g., about 5,000, above about 10,000 or above about 25,000.

Referring now to FIG. 5, upon crosslinking composite 32 can be provided. Composite 32 includes first 26″ and third 30″ and middle regions 28″, corresponding to preforms regions 26′, 28′ and 30′ respectively. An interface is defined between regions 26″ and 28″ and 28″ and 30″.

In some embodiments, prior to crosslinking, the preform 24 is cooled, and optionally stored for a desired amount of time (e.g., for a time it takes to move it to an irradiating facility), and the preform is crosslinked by irradiating.

In some embodiment and if desired, e.g., to enhance wear resistance, the irradiated preform can be annealed.

In an alternative embodiment, preform 2 or 24 can be made by selecting a filled preform, e.g., a preform that is homogenously filled with an antioxidant at a desired level, and then the concentration of the antioxidant can be reduced in one or more selected regions. For example, the concentration is reduced by leaching the preform in a solvent, such as an alcoholic solvent or a supercritical solvent, such as carbon dioxide.

In certain embodiments, the filled preform is prepared by infusing the antioxidant into a non-filled preform, and, optionally annealing the infused preform to uniformly disperse the antioxidant.

In other embodiments, the filled preform is prepared by combining the substantially non-crosslinked polymeric with the antioxidant to provide a molding material, and then molding the molding material into a desired shape.

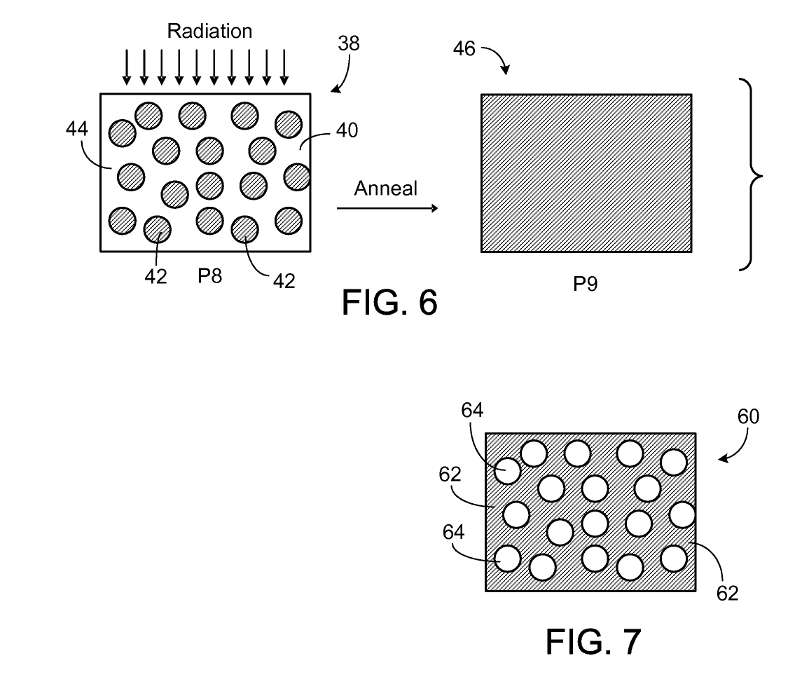

Referring now to FIG. 6, a polymeric preform 38 includes a matrix 40 that includes a first polymeric material having a first concentration of a first antioxidant dispersed therein, and a plurality of spaced apart regions 42 within the matrix 40 that includes a second polymeric material having a second concentration different from the first concentration of a second antioxidant dispersed therein. As shown, in some embodiments, an interface 44 defined between each region and the matrix. As shown in FIG. 6, preform 38 can be crosslinked, followed by annealing to homogenously distribute the antioxidant(s) to provide preform 46.

In some embodiments, the regions are also discrete and the discrete regions are approximately circular in cross-section. In other embodiments, the regions are not discrete, but are rather interconnected.

In some implementations, the first concentration is higher than the second concentration.

In some embodiments, the first polymeric material includes a substantially non-crosslinked polymeric material.

In certain embodiments, the first and second polymeric materials are the same polymeric material, such as a polyolefin (e.g., UHMWPE).

Referring now to FIG. 7, after crosslinking composite 38, composite 60 can be provided. Composite 60 includes a matrix 62 that includes a first crosslinked polymeric material having a first average crosslink density and a plurality of spaced apart regions 64, each including a second crosslinked polymeric material having a second average crosslink density different from the first average crosslink density. As shown in FIG. 7, in some embodiments, an interface is defined between each region and the matrix

Preform 38 is made, e.g., by combining a first substantially non-crosslinked polymeric material with a first antioxidant to provide a first molding compound having a first concentration of the first antioxidant in the first molding compound; combining a second substantially non-crosslinked polymeric material with a second antioxidant to provide a second molding compound having second concentration of the second antioxidant higher than the first antioxidant in the first molding compound; combining the first molding compound and the second molding compound to provide a composite molding compound; and then molding the composite molding compound in a desired shape to provide composite preform 38. In some embodiments, the concentration of the first antioxidant is zero. In certain instances, the first substantially non-crosslinked polymeric material is combined with the first antioxidant with the aid of a solvent.

In other embodiments, preform 38 is made by combining a substantially non-crosslinked polymeric material with a solid antioxidant at a temperature below a melting point and/or solidification point of the solid antioxidant to provide a molding compound; and molding the molding compound at a temperature above a melting point and/or solidification point of the solid antioxidant in a desired shape to provide the composite preform 38 having regions which are relatively enriched in the antioxidant and regions which are relatively depleted of the antioxidant.

Other preforms are made by selecting a filled preform, that includes a substantially non-crosslinked polymeric material having an antioxidant dispersed therein, e.g., that is homogenously dispersed therein; infusing a liquid material into the filled preform that is a solvent for the antioxidant at about room temperature, and is a poor solvent or non-solvent for the antioxidant about a melting point and/or solidification point of the liquid material; cooling the infused liquid preform below a melting point and/or solidification point of the antioxidant in the liquid material; and removing some of the liquid material from the cooled, liquid infused preform to provide a composite preform having first regions that are relatively enriched in the antioxidant and second regions that are relatively depleted of the antioxidant. In some embodiments, the liquid material includes an alcohol, such as ethanol, and/or a supercritical fluid. In some instances, the preform is cooled to above a melting point of the liquid material, and then the liquid material is removed by applying a vacuum. In other instances, the preform is cooled to below a melting point and/or solidification point of the liquid material, and then the solidified liquid material is removed by freeze-drying.

Still other preforms are made by selecting a filled preform that includes a substantially non-crosslinked polymeric material having an antioxidant dispersed therein; infusing a first liquid material into the filled preform that is a solvent for the antioxidant to provide a solvent infused preform; infusing a second liquid material into the solvent infused preform that is a non-solvent for the antioxidant, but miscible with the first solvent to cause solidification of the antioxidant to provide a preform having solid particles of antioxidant dispersed therein; removing some of the first or second liquid material to provide a composite preform having first regions that are relatively enriched in the antioxidant and second regions that are relatively depleted of the antioxidant. In some embodiments, the antioxidant is solidified by cooling. In certain instances, the first and/or second liquid materials include ethanol and/or a supercritical fluid.

In some instances, crosslinking cooled preforms can be advantageous, e.g., preforms that are cooled to slightly above a glass transition temperature of the substantially non-crosslinked polymeric material to. In such instances, diffusion rates of materials, such as antioxidants, in polymeric materials are lowered. In some instances, the materials can include an antioxidant, and the polymeric material can be cooled to below a solidification temperature of the antioxidant to sequester the antioxidant. After crosslinking and upon warming, the antioxidant can be re-activated to prevent oxidation.

For example, in some embodiments, preforms are made by infusing an antioxidant into a preform that includes a substantially non-crosslinked polymeric material to provide an antioxidant infused preform; cooling the antioxidant infused preform to a temperature above a glass transition temperature of the substantially non-crosslinked polymeric material to provide a cooled, infused preform; and crosslinking the cooled, infused preform to provide a crosslinked preform. For example, the antioxidant can have one or more melting points and/or solidification points and the antioxidant infused preform can be cooled to below a melting point and/or a solidification point of the antioxidant. When the method includes an annealing step, the annealing can be carried out in the presence of a reactive gas that can quench residual reactive species trapped in the crosslinked polymeric material. For example, the reactive gas can include one or more unsaturated compounds.

Other preforms can be made, e.g., by combining a first substantially non-crosslinked polymeric material with a first antioxidant to provide a first molding compound having a first concentration of the first antioxidant in the first molding compound; combining a second substantially non-crosslinked polymeric material with a second antioxidant to provide a second molding compound having second concentration of the second antioxidant higher than the first in the first molding compound; combining the first molding and the second molding compound to provide a composite molding compound; molding the composite molding compound in a desired shape to provide a composite preform; cooling the composite preform to a temperature above a glass transition temperature of the first and/or second substantially non-crosslinked polymeric material to provide a cooled preform; and crosslinking the cooled, infused preform to provide a crosslinked preform. For example, the concentration of the first antioxidant can be zero.

Other preforms are made by combining a substantially non-crosslinked polymeric material with a solid antioxidant at a temperature below a melting point and/or a solidification point of the solid antioxidant to provide a molding compound; molding the molding compound at a temperature above a melting and/or solidification point of the solid antioxidant in a desired shape to provide a composite preform having regions which are relatively enriched in said antioxidant and regions which are relatively depleted of said antioxidant; cooling the composite preform to a temperature above a glass transition temperature of the substantially non-crosslinked polymeric material to provide a cooled preform; and crosslinking the cooled, infused preform to provide a crosslinked preform.

Other preforms are made by selecting a filled preform that includes a substantially non-crosslinked polymeric material having an antioxidant dispersed therein; infusing a liquid material into the filled preform that is a solvent for the antioxidant at about room temperature, but a poor or non-solvent for the antioxidant about a melting point of the liquid material; cooling the infused liquid preform below a solidification point of the antioxidant in the liquid material; removing some of the liquid material from the cooled, liquid infused preform to provide a composite preform having regions which are relatively enriched in the antioxidant and regions which are relatively depleted of the antioxidant; cooling the composite preform to a temperature above a glass transition temperature of the substantially non-crosslinked polymeric material to provide a cooled preform; and crosslinking the cooled, infused preform to provide a crosslinked preform.

Still other preforms are made by selecting a filled preform that includes a substantially non-crosslinked polymeric material having an antioxidant dispersed therein; infusing a first liquid material into the filled preform that is a solvent for the antioxidant to provide a solvent infused preform; infusing a second liquid material into the solvent infused preform that is a non-solvent for the antioxidant, but miscible with the first solvent to cause solidification of the antioxidant to provide a preform having solid particles of antioxidant dispersed therein; removing some of the first or second liquid material to provide a composite preform having regions which are relatively enriched in the antioxidant and regions which are relatively depleted of said antioxidant; cooling the composite preform to a temperature above a glass transition temperature of the substantially non-crosslinked polymeric material to provide a cooled preform; and crosslinking the cooled, infused preform to provide a crosslinked preform.

Polymeric Materials:

The substantially non-crosslinked polymeric material can be, e.g., a polyolefin, e.g., a polyethylene such as UHMWPE, a low density polyethylene (e.g., having a density of between about 0.92 and 0.93 g/cm³, as determined by ASTM D792), a linear low density polyethylene, a very-low density polyethylene, an ultra-low density polyethylene (e.g., having a density of between about 0.90 and 0.92 g/cm³, as determined by ASTM D792), a high density polyethylene (e.g., having a density of between about 0.95 and 0.97 g/cm³, as determined by ASTM D792), or a polypropylene, a polyester such as polyethylene terephthalate, a polyamide such as nylon 6, 6/12, or 6/10, a polyethyleneimine, an elastomeric styrenic copolymer such as styrene-ethylene-butylene-styrene copolymer, or a copolymer of styrene and a diene such as butadiene or isoprene, a polyamide elastomer such as a polyether-polyamide copolymer, an ethylene-vinyl acetate copolymer, or compatible blends of any of these polymers. The substantially non-crosslinked polymeric material can be processed in the melt into a desired shape, e.g., using a melt extruder, or an injection molding machine, or it can be pressure processed with or without heat, e.g., using compression molding or ram extrusion.

The substantially non-crosslinked polymeric material can be purchased in various forms, e.g., as powder, flakes, particles, pellets, or other shapes such as rod (e.g., cylindrical rod). Powder, flakes, particles, or pellets can be shaped into a preform by extrusion, e.g., ram extrusion, melt extrusion, or by molding, e.g., injection or compression molding. Purchased shapes can be machined, cut, or other worked to provide the desired shape. Polyolefins are available, e.g., from Hoechst, Montel, Sunoco, Exxon, and Dow; polyesters are available from BASF and Dupont; nylons are available from Dupont and Atofina, and elastomeric styrenic copolymers are available from the KRATON Polymers Group (formally available from Shell). If desired, the materials may be synthesized by known methods. For example, the polyolefins can be synthesized by employing Ziegler-Natta heterogeneous metal catalysts, or metallocene catalyst systems, and nylons can be prepared by condensation, e.g., using transesterification.

In some embodiments, it is desirable for the substantially non-crosslinked polymeric material to be substantially free of biologically leachable additives that could leach from an implant in a human body or that could interfere with the crosslinking of the substantially non-crosslinked polymeric material.

In particular embodiments, the polyolefin is UHMWPE. For the purposes of this disclosure, an ultrahigh molecular weight polyethylene is a material that consists essentially of substantially linear, non-branched polymeric chains consisting essentially of —CH₂CH₂— repeat units. The polyethylene has an average molecular weight in excess of about 500,000, e.g., greater than 1,000,000, 2,500,000, 5,000,000, or even greater than 7,500,000, as determined using a universal calibration curve. In such embodiments, the UHMWPE can have a degree of crystallinity of greater than 50 percent, e.g., greater than 51 percent, 52 percent, 53 percent, 54 percent, or even greater than 55 percent, and can have a melting point of greater than 135° C., e.g., greater than 136, 137, 138, 139 or even greater than 140° C. Degree of crystallinity of the UHMWPE is calculated by knowing the mass of the sample (in grams), the heat absorbed by the sample in melting (E in J/g), and the heat of melting of polyethylene crystals (ΔH=291 J/g). Once these quantities are known, degree of crystallinity is then calculated using the formula below:

Degree of Crystallinity=E/(sample weight)ΔH.

For example, differential scanning calorimetry (DSC) can be used to measure the degree of crystallinity of the UHMWPE sample. To do so, the sample is weighed to a precision of about 0.01 milligrams, and then the sample is placed in an aluminum DSC sample pan. The pan holding the sample is then placed in a differential scanning calorimeter, e.g., a TA Instruments Q-1000 DSC, and the sample and reference are heated at a heating rate of about 10° C./minute from about −20° C. to 180° C., cooled to about 10° C., and then subjected to another heating cycle from about −20° C. to 180° C. at 10° C./minute. Heat flow as a function of time and temperature is recorded during each cycle. Degree of crystallinity is determined by integrating the enthalpy peak from 20° C. to 160° C., and then normalizing it with the enthalpy of melting of 100 percent crystalline polyethylene (291 J/g). Melting points can also be determined using DSC.

In some embodiments, the substantially non-crosslinked polymeric material is substantially amorphous.

In some embodiments, the substantially non-crosslinked polymeric material includes one or more antioxidants, such as any of the antioxidants described herein.

Crosslinking:

In some embodiments, the crosslinking occurs at a temperature about a glass transition temperature of a polymeric material, such as about 5° C. above a glass transition temperature of the polymeric material, e.g., about 10, 15, 20, or 25° C. above a glass transition temperature of the polymeric material. In some embodiments, the crosslinking occurs at a temperature from about −25° C. to above a melting point of the substantially non-crosslinked polymeric material, e.g., from about −10° C. to about a melting point of the substantially non-crosslinked polymeric material, e.g., room temperature to about the melting point. Irradiating above a melting point of the substantially non-crosslinked polymeric material can, in some instance, increase crosslink density.

In some embodiments, the crosslinking occurs at a pressure, e.g., from about nominal atmospheric pressure to about 50 atmospheres of pressure, e.g., from about nominal atmospheric pressure to about 5 atmospheres of pressure. Crosslinking above atmospheric pressure can, e.g., increase crosslink density.

In some embodiments, the crosslinking of is performed at a temperature that substantially prevents re-entanglement of polymer chains.

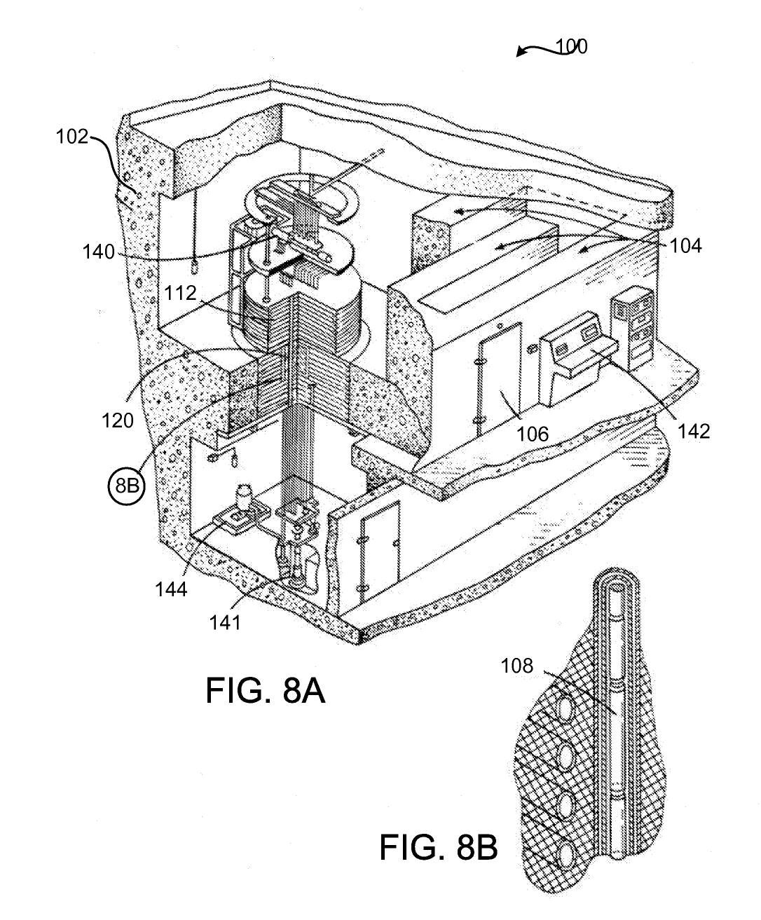

In some embodiments, an ionizing radiation (e.g., an electron beam, x-ray radiation or gamma radiation) is employed to crosslink the substantially non-crosslinked polymeric material. In specific embodiments, gamma radiation is employed to crosslink the substantially non-crosslinked polymeric material. Referring to FIGS. 8A and 8B, a gamma irradiator 100 includes gamma radiation sources 108, e.g., ⁶⁰Co pellets, a working table 110 for holding the substantially non-crosslinked polymeric material to be irradiated, and storage 112, e.g., made of a plurality iron plates, all of which are housed in a concrete containment chamber 102 that includes a maze entranceway 104 beyond a lead-lined door 106. Storage 112 includes a plurality of channels 120, e.g., 16 or more channels, allowing the gamma radiation sources 108 to pass through storage 112 on their way proximate the working table 110.

In operation, the substantially non-crosslinked polymeric material to be irradiated is placed on working table 110. The irradiator is configured to deliver the desired dose rate and monitoring equipment is connected to experimental block 140. The operator then leaves the containment chamber 102, passing through the maze entranceway 104 and through the lead-lined door 106. The operator uses a control panel 142 to instruct a computer to lift the radiation sources 108 into working position using cylinder 141 attached to a hydraulic pump 144. If desired, the sample can be housed in a container that maintains the sample under an inert atmosphere such as nitrogen or argon.

In embodiments in which the irradiating is performed with electromagnetic radiation (e.g., as above), the electromagnetic radiation can have energy per photon of greater than 10² eV, e.g., greater than 10³, 10⁴, 10⁵, 10⁶, or even greater than 10⁷ eV. In some embodiments, the electromagnetic radiation has an energy per photon of between 10⁴ and 10⁷, e.g., between 10⁵ and 10⁶ eV. The electromagnetic radiation can have a frequency of, e.g., greater than 10¹⁶ Hz, greater than 10¹⁷ Hz, 10¹⁸, 10¹⁹, 10²⁰, or even greater than 10²¹ Hz. In some embodiments, the electromagnetic radiation has a frequency of between 10¹⁸ and 10²² Hz, e.g., between 10¹⁹ to 10²¹ Hz.

In some embodiments, a beam of electrons is used as the radiation source. Electron beams can be generated, e.g., by electrostatic generators, cascade generators, transformer generators, low energy accelerators with a scanning system, low energy accelerators with a linear cathode, linear accelerators, and/or pulsed accelerators. Electrons as an ionizing radiation source can be useful to crosslink outer portions of the substantially non-crosslinked polymeric material, e.g., inwardly from an outer surface of less than 0.5 inch, e.g., less than 0.4 inch, 0.3 inch, 0.2 inch, or less than 0.1 inch. In some embodiments, the energy of each electron of the electron beam is from about 0.3 MeV to about 10.0 MeV (million electron volts), e.g., from about 0.5 MeV to about 3.0 MeV, or from about 0.7 MeV to about 1.50 MeV.

In some embodiments, the irradiating (with any radiation source) is performed until the sample receives a dose of at least 0.25 Mrad (2.5 kGy), e.g., at least 1.0 Mrad (10 kGy), at least 2.5 Mrad (25 kGy), at least 5.0 Mrad (50 kGy), or at least 10.0 Mrad (100 kGy). In some embodiments, the irradiating is performed until the sample receives a dose of between 1.0 Mrad and 6.0 Mrad, e.g., between 1.5 Mrad and 4.0 Mrad.

In some embodiments, the irradiating is performed at a dose rate of between 5.0 and 1500.0 kilorads/hour, e.g., between 10.0 and 750.0 kilorads/hour, or between 50.0 and 350.0 kilorads/hours. Low rates can generally maintain the temperature of the sample, while high dose rates can cause heating of the sample.

In some embodiments, radical sources, e.g., azo materials, e.g., monomeric azo compounds such as 2,2′-azobis(N-cyclohexyl-2-methylpropionamide) (I), or polymeric azo materials such as those schematically represented by (II) in which the linking chains include polyethylene glycol units (N is, e.g., from about 2 to about 50,000), and/or polysiloxane units, peroxides, e.g., benzoyl peroxide, or persulfates, e.g., ammonium persulfate (NH₄)₂S₂O₈, are employed to crosslink the substantially non-crosslinked polymeric material.

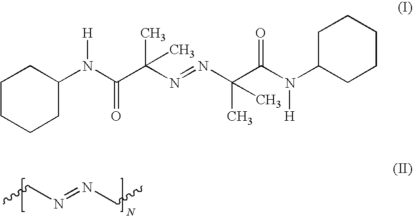

Azo materials are available from Wako Chemicals USA, Inc. of Richmond, Va.

Generally, to crosslink the substantially non-crosslinked polymeric material, the material is mixed, e.g., powder or melt mixed, with the radical source, e.g., using a roll mill, e.g., a Banbury® mixer or an extruder, e.g., a twin-screw extruder with counter-rotating screws. An example of a Banbury® mixer is the F-Series Banbury® mixer, manufactured by Farrel. An example of a twin-screw extruder is the WP ZSK 50 MEGAcompounder™, manufactured by Krupp Werner & Pfleiderer. Generally, the compounding or powder mixing is performed at the lowest possible temperature to prevent premature crosslinking. The sample is then formed into the desired shape, and further heated (optionally with application of pressure) to generate radicals in sufficient quantities to crosslink the sample.

Measuring Crosslink Density and Molecular Weight Between Crosslinks:

Crosslink density measurements are performed following the procedure outlined ASTM F2214-03. Briefly, rectangular pieces of the crosslinked UHMWPE are set in dental cement, and sliced into thin sections that are 2 mm thick. Small sections are cut out from these thin sections using a razor blade, giving test samples that are 2 mm thick by 2 mm wide by 2 mm high. A test sample is placed under a quartz probe of a dynamic mechanical analyzer (DMA), and an initial height of the sample is recorded. Then, the probe is immersed in o-xylene, heated to 130° C., and held at this temperature for 45 minutes. The UHMWPE sample is allowed to swell in the hot o-xylene until equilibrium is reached. The swell ratio qₛ for the sample is calculated using a ratio of a final height H_{f} to an initial height H0 according to formula (1):

qₛ=[H_{f}/H₀]³ (1).

The crosslink density v_{d} is calculated from qₛ, the Flory interaction parameter χ, and the molar volume of the solvent φ₁ according to formula (2):

$${v}_{d} = \frac{ln ( 1 - {q}_{s}^{- 1} ) + {q}_{s}^{- 1} + χ {q}_{s}^{- 2}}{{ϕ}_{1} ( {q}_{s}^{- 1 / 3} - {q}_{s}^{- 1} / 2 )} , \qquad ( 2 )$$

where χ is 0.33+0.55/qs, and φ₁ is 136 cm³/mol for UHMWPE in o-xylene at 130° C. Molecular weight between crosslinks M_{c} can be calculated from v_{d}, and the specific volume of the polymer ν according to formula (3):

M_{c}=(νv_{d})⁻¹ (3).

Measurement of swelling, crosslink density and molecular weight between crosslinks is described in Muratoglu et al., Biomaterials, 20, 1463-1470 (1999).

Annealing:

Any material described herein (crosslinked or non-crosslinked) can annealed. For example, a preform can be annealed below or above a melting point of a material of the preform.

For example, after crosslinking, a pressure of greater than 10 MPa is applied to the crosslinked polymeric material, while heating the crosslinked material below a melting point of the crosslinked polymeric material at the applied pressure for a sufficient time to substantially reduce the reactive species trapped within the crosslinked polymeric material matrix, e.g., free radicals, radical cations, or reactive multiple bonds. Quenching such species produces an oxidation resistant crosslinked polymeric material. The high pressures, and temperatures employed also increase the crystallinity of the crosslinked polymeric material, which can, e.g., improve wear performance.

In some embodiments, the pressure applied is greater than 25 MPa, e.g., greater than 50 MPa, 75 MPa, 100 MPa, 150 MPa, 200 MPa, 250 MPa, 350 MPa, 500 MPa, 750 MPa, 1,000 MPa, or greater than 1,500 MPa. In some embodiments, the pressure is maintained for greater than 30 seconds, e.g., greater than 45 seconds, 60 seconds, 2.5 minutes, 5.0 minutes, 10 minutes, 20 minutes, 30 minutes, 60 minutes, greater than 90 minutes, or even greater than 120 minutes, before release of pressure back to nominal atmospheric pressure.

In some embodiments, prior to the application of any pressure above nominal atmospheric pressure, the crosslinked polymeric material is heated to a temperature that is between about 25° C. to about 0.5° C. below a melting point of the crosslinked polymeric material. This can enhance crystallinity of the crosslinked polymeric material prior to the application of any pressure.

In some embodiments, a pressure of above about 250 MPa is applied at a temperature of between about 100° C. to about 1° C. below a melting point of the crosslinked polymeric material at the applied pressure, and then the material is further heated above the temperature, but below a melting point of the crosslinked polymeric material at the applied pressure.

Various other annealing methods are described by Bellare in U.S. Ser. No. 11/359,845, filed Feb. 21, 2006.

Manufacture of Preforms:

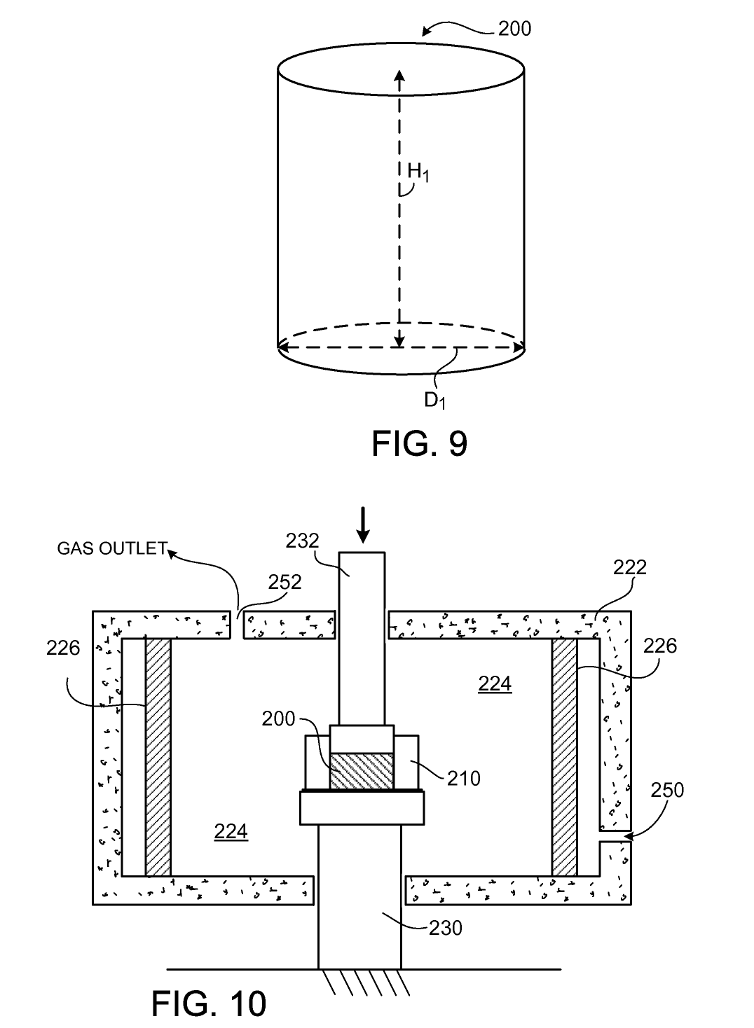

Referring now to FIGS. 9 and 10, in particular embodiments, to make a crosslinked UHMWPE cylindrical preform that is resistant to oxidation, a substantially non-crosslinked cylindrical preform 200 is obtained, e.g., by machining rod stock to a desired height H₁ and desired diameter D₁. Preform 200 can be made from a substantially non-crosslinked UHMWPE having a melting point of around 138° C., and a degree of crystallinity of about 52.0 percent. This crystallinity is either reduced, e.g., by heating the preform 200 above the melting point of the UHMWPE, and then cooling, or the crystallinity is maintained, but not increased. Preform 200 is then subjected to gamma radiation, e.g., 50 kGr (5 Mrad; 1 Mrad=10 KGr) of gamma radiation, to crosslink the UHMWPE. After irradiation, the sample is press-fit into a pressure cell 210, and then the pressure cell 210 is placed into a furnace assembly 220. Furnace assembly 220 includes an insulated enclosure structure 222 that defines an interior cavity 224. Insulated enclosure structure 222 houses heating elements 224 and the pressure cell 210, e.g., that is made stainless steel, and that is positioned between a stationary pedestal 230 and a movable ram 232.

The crosslinked UHMWPE sample is first heated to a temperature Temp₁ below the melting point of the UHMWPE, e.g., 130° C., without the application of any pressure above nominal atmospheric pressure. After such heating, pressure P, e.g., 500 MPa of pressure, is applied to the sample, while maintaining the temperature Temp₁. Once pressurization has stabilized, the sample is further heated to a temperature Temp₂, e.g., 160, 180, 200, 220, or 240° C., while maintaining the pressure P. As noted, pressure is applied along a single axis by movable ram 232, as indicated by arrow 240. Pressure at the given temperature Temp₂ is generally applied for 10 minutes to 1 hour. During any heating, a gas such as an inert gas, e.g., nitrogen or argon, can be delivered to interior cavity 224 of insulated enclosure structure 222 through an inlet 250 that is defined in a wall of the enclosure structure 222. The gas exits through an outlet 252 that is defined in a wall of the enclosure structure, which maintains a pressure in the cavity 224 of about nominal atmospheric pressure. After heating to Temp₂ and maintaining the pressure P, the sample is allowed to cool to room temperature, while maintaining the pressure P, and then the pressure is finally released. The pressure cell 210 is removed from furnace 220, and then the oxidation resistant UHMWPE is removed from pressure cell 210.

Using the methods illustrated in FIGS. 3-6, by starting with an UHMWPE having a melting point of around 138° C., and a degree of crystallinity of about 52.0 percent, and using a temperature of Temp₂ of about 240° C., and a pressure P of about 500 MPa, one can obtain an oxidation resistant crosslinked UHMWPE that has a melting point greater than about 141° C., e.g., greater than 142, 143, 144, 145, or even greater than 146° C., and a degree of crystallinity of greater than about 52 percent, e.g., greater than 53, 54, 55, 56, 57, 58, 59, 60, 65, or even greater than 68 percent. In some embodiments, the crosslinked UHMWPE has a crosslink density of greater than about 100 mol/m³, e.g., greater than 200, 300, 400, 500, 750, or even greater than 1,000 mol/m³, and/or a molecular weight between crosslinks of less than about 9,000 g/mol, e.g., less than 8,000, 7,000, 6,000, 5,000, or even less than about 3,000 g/mol.

Quenching Materials:

A “quenching material” refers to a mixture of gases and/or liquids (at room temperature) that contain gaseous and/or liquid component(s) that can react with residual free radicals and/or radial cations to assist in the recombination of the residual free radicals and/or radical cations.

Any material and/or preform described herein (crosslinked or non-crosslinked) can processed, e.g., annealed and/or crosslinked, in the presence of a quenching material.

The gases can be, e.g., acetylene, chloro-trifluoro ethylene (CTFE), ethylene, or other unsaturated compound. The gases or the mixtures of gases may also contain noble gases such as nitrogen, argon, neon, and the like. Other gases such as carbon dioxide or carbon monoxide may also be present in the mixture. In applications where the surface of a treated material is machined away during the device manufacture, the gas blend could also contain oxidizing gases such as oxygen. The quenching material can be one or more dienes, e.g., each with a different number of carbons, or mixtures of liquids and/or gases thereof. An example of a quenching liquid is octadiene or other dienes, which can be mixed with other quenching liquids and/or non-quenching liquids, such as a hexane or a heptane.

Antioxidants:

Generally, because many of the materials will be used in medical devices, some even for permanent implantation, useful antioxidants are typically either Generally Recognized as Safe direct food additives (GRAS) in Section 21 of the Code of Federal Regulations or are EAFUS-listed, i.e., included on the Food and Drug Administration's list of “everything added to food in the United States.” Other useful antioxidants can also be those that could be so listed, or those that are classified as suitable for direct or indirect food contact. Examples of antioxidants which can be used in any of the methods described herein include, alpha- and delta-tocopherol; propyl, octyl, or dodecyl gallates; lactic, citric, and tartaric acids and salts thereof as well as orthophosphates. In some instances, a preferable antioxidant is vitamin E. Still other antioxidants are available form Eastman under the tradename TENOX. For example other antioxidants include tertiary-butylhydroquinone (TBHQ), butylated hydroxyanisole (BHA), butylated hydroxytoluene (BHT), or mixtures of any of these or the prior-mentioned antioxidants.

Applications

The oxidation resistant crosslinked polymeric materials can be used in any application for which oxidation resistance, long-term stability, high wear resistance, low coefficient of friction, chemical/biological resistance, fatigue and crack propagation resistance, and/or enhanced creep resistance are desirable. For example, the oxidation resistant crosslinked polymeric materials are well suited for medical devices. For example, the oxidation resistant crosslinked polymeric material can be used as an acetabular liner, a finger joint component, an ankle joint component, an elbow joint component, a wrist joint component, a toe joint component, a hip replacement component, a tibial knee insert, an intervertebral disc, a heart valve, a stent, or part of a vascular graft.

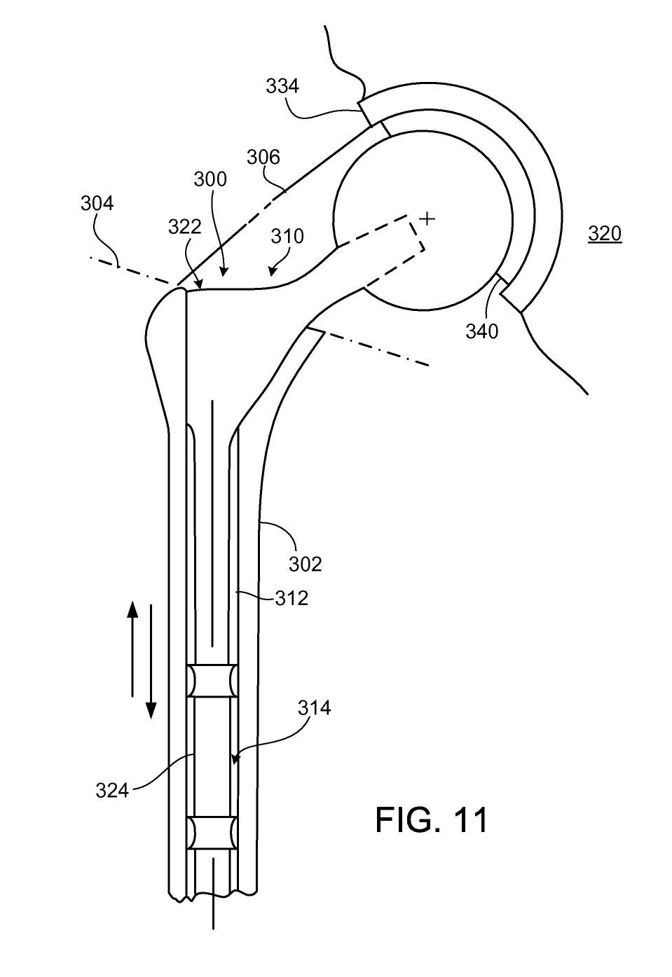

In a particular embodiment, the oxidation resistant crosslinked polymeric material is used as a liner in a hip replacement prostheses. Referring to FIG. 11, joint prosthesis 300, e.g., for treatment of osteoarthritis, is positioned in a femor 302, which has been resected along line 304, relieving the epiphysis 306 from the femur 302. Prosthesis 300 is implanted in the femur 302 by positioning the prosthesis in a cavity 310 formed in a portion of cancellous bone 312 within medullary canal 314 of the femur 302. Prosthesis 300 is utilized for articulating support between femur 302, and acetabulum 320. Prosthesis 300 includes a stem component 322, which includes a distal portion 324 disposed within cavity 310 of femur 302. Prosthesis 300 also includes a cup 334, which is connected to the acetabulum 320. A liner 340 is positioned between the cup 334 and the stem 322. Liner 44 is made of the oxidation resistant crosslinked polymeric material described herein.

Non-Uniform Crosslinking

In some embodiments, non-uniform crosslinking in a polymeric article, such as ultra-high molecular weight polyethylene, is accomplished by one or more of the following methods: (1) varying antioxidant concentrations in different parts of the article, e.g., an implant; (2) using low powered electron beam radiation that does not fully penetrate the article; and (3) by using appropriate masks made of metals, ceramics, or polymers that would shield certain regions of the article from irradiation. These methods will each independently provide non-uniform crosslinking, as will combinations of these methods, and the invention contemplates the use of any combination of two or more of these methods, in any order or simultaneously, e.g., methods (1) and (2), (1) and (3), (2) and (3), or (1), (2), and (3) combined.

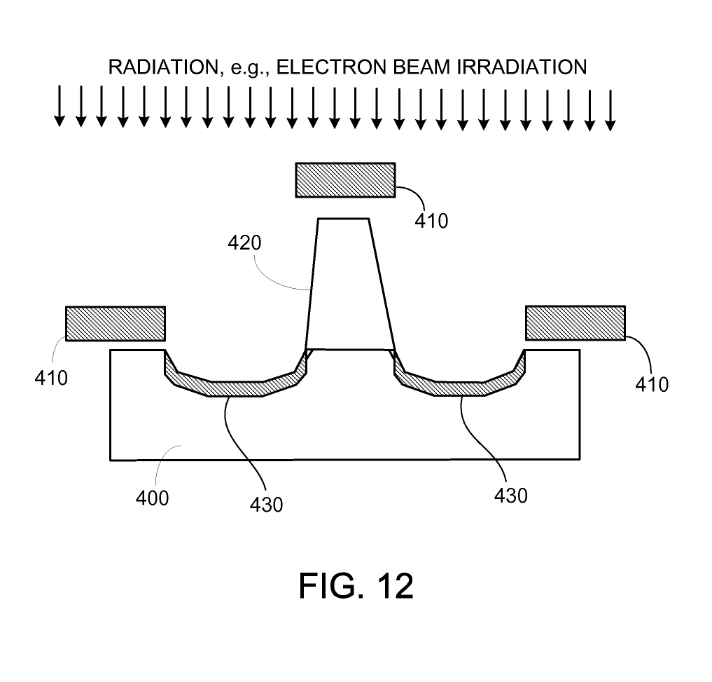

For example, as shown in FIG. 12, an ultra-high molecular weight polyethylene tibial plateau 400 containing a uniform concentration of Vitamin E is irradiated with low powered radiation, such as an electron beam (e.g., in the range of 100 kEv−3 MeV) that is unable to penetrate more than 10 mm thickness of the implant. The use of masks 410 in appropriate parts of the tibial plateau will ensure that certain regions are not irradiated. In the case of tibial plateaus, which have a post 420, it is preferable for the post not to be crosslinked. In some embodiments, the only regions of the UHMWPE implant that are crosslinked are the regions that undergo wear due to articulation against a metallic or ceramic counterface, denoted by the dark regions 430 in the tibial plateau of FIG. 12.

The presence of Vitamin E or a similar biocompatible antioxidant is important for an article that is crosslinked, as antioxidants can render the article wear resistant and also oxidation-resistant. If an antioxidant is not used, then thermal techniques, such as annealing at a temperature below the melting temperature or to completely melt the article, may compromise the dimensional tolerances of the implant. In some embodiments, thermal methods are rendered unnecessary if the article includes an antioxidant in excess of 0.05%.

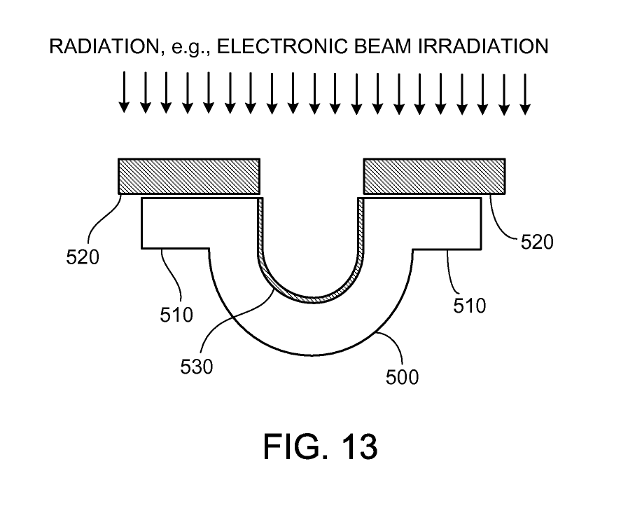

FIG. 13 shows a UHMWPE acetabular cup 500 containing a uniform concentration of Vitamin E. In some embodiments, the rim regions 510 of the implant are not crosslinked and hence are covered by masks 520. The use of a low powered electron beam ensures that only the near surface region 530 of the acetabular cup, which undergoes wear, is being irradiated. The use of antioxidant can make it unnecessary to heat the implant to remove free radicals to make it oxidation-resistant.

In some embodiments, the polymeric materials are selectively crosslinked to a given desired density by changing one or more of the methods mentioned above, in any combination. For example, the antioxidant concentrations in different parts of the implant can be varied and gamma radiation, which permeates throughout the polymeric materials, can be used for crosslinking. In some embodiments, low powered electron beam radiation can be used for crosslinking polymer materials having a uniform or non-uniform distribution of one or more antioxidants.

In some embodiments, masks made of metals, ceramics, or polymers can be used on one or more portions of polymeric material having a non-uniform distribution of one or more antioxidants, and a low-powered electron beam radiation can be used to selectively crosslink portions of the polymeric materials that are not covered by masks. Regions in the polymeric materials having a large local concentration of antioxidants can be less crosslinked than regions having a small local concentration of antioxidants. A decreasing gradient of crosslink density can be created from the surface of irradiation to the core of the polymeric materials. For example, the level of crosslinking parallel to the direction of the irradiation beam can be varied as a function of proximity to the irradiation beam. In some embodiments, the level of energy of the irradiation is used to affect the level of crosslinking in the direction of the beam. Therefore, by changing the level of energy, one can control the penetration depth and thus the crosslinking density for a given depth within the polymeric material.

In some embodiments, masked portions of the polymeric materials can have a low crosslink density compared to portions that are not masked. In effect, the masking can be used to change the level of crosslinking in a direction transverse to the irradiating beam. By using multiple masks, or different or overlapping masks, e.g., simultaneously or in succession, different levels and gradients of crosslinking density can be achieved.

### EXAMPLES

The disclosure is further described in the following examples, which do not limit its scope.

Materials and Apparatuses

Non-crosslinked, ram-extruded rod stock of GUR 1050 UHMWPE (Hoechst-Ticona, Bayport, Tex.) was purchased from PolyHi Solidur of Fort Wayne, Ind. Gamma radiation was performed in Sterix Isomedix's, Northborough, Mass. facility. Pressure was applied to the crosslinked samples using a CARVER® Model 3912 eleven ton, four column manual hydraulic press.

### Example 1

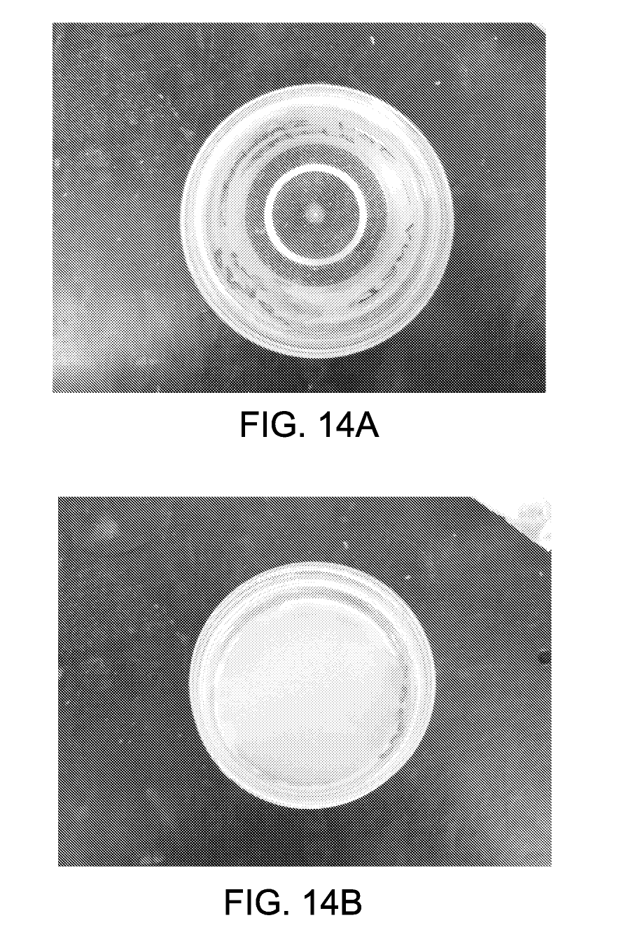

5 grams of vitamin E was dissolved in 20 grams of ethanol that was contained in a wide-mouth glass jar at room temperature. A slightly yellow, but clear and homogenous solution resulted, as shown in FIG. 14A. When the container was placed in a refrigerator maintained at −80° C. overnight, the clear solution became cloudy, indicating a suspension of Vitamin E in ethanol, rather than a homogenous solution, as shown in FIG. 14B. The cloudy suspension became clear again upon warming to room temperature. This experiment indicates (1) that low temperature can be used to solidify vitamin E when it is initially (at room temperature) homogenously dissolved in an alcoholic solution; and (2) that the solidification is reversible. This would imply that when a polymeric material has an infused solvent carrying an antioxidant such as vitamin E, that solidification of the antioxidant can be effected within the polymeric material by using low temperature.

### Example 2

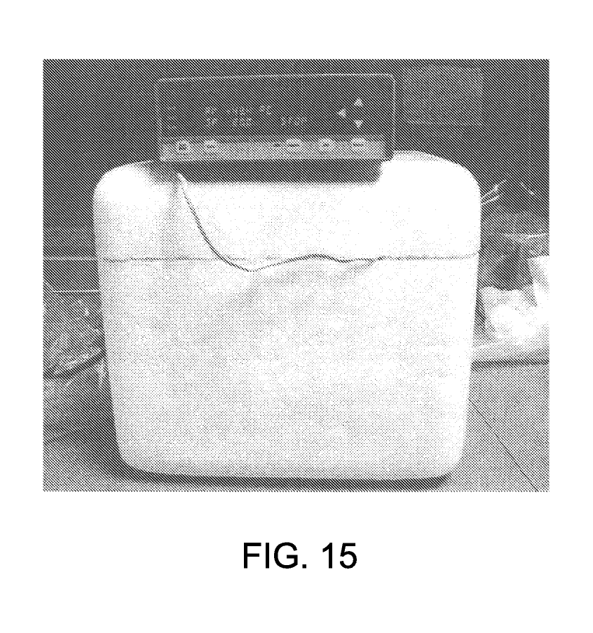

Alpha-tocopherol (Fisher Scientific, Alfa Aesar, 98%) was blended with into seven beakers that each contained about 50 mL of ethanol and stirred until homogeneous solutions resulted. To make the solutions, an amount of alpha-tocopherol was utilized to provide the weight percentages described below. To each beaker was added 20 grams of GUR 1050 UHMWPE powder, and then the solution was heated at 40° C. and allowed to set overnight to evaporate the solvent from each beaker. The resulting powders contained UHMWPE and alpha-tocopherol at a 0.05 weight percent, 0.1 weight percent, 0.5 weight percent, 1 weight percent, 2 weight percent, 5 weight percent, and a 10 weight percent level. Each batch of powder was placed in a cylindrical mold with a 1″ inner diameter and an insulating jacket to prevent heat loss. The mold was placed on a Carver hydraulic press with platens preheated to about 210° C. A load of about 1 T was applied to the plunger for a period of about one hour to provide molded uniform cylinders of about 1 inch in diameter and 2 inches in length. Thereafter, all specimens were cut in half and set aside. One half of the specimens was placed in a Styrofoam box containing dry ice, as shown in FIG. 15 (the other half was irradiated at room temperature). A thermocouple was that was in thermal equilibrium with a UHMWPE specimen showed that the temperature of the specimens decreased to approximately −50° C., and were maintained at this temperature overnight. The specimens were repacked in dry ice and submitted for 50 kGy gamma radiation (Steris Isomedix, Northborough, Mass.). The package was scheduled for immediate processing to ensure that the dry ice did not evaporate during the coarse of the radiation. This Styrofoam box was placed in a large cardboard container, which also contained the corresponding UHMWPE specimens to be irradiated at room temperature. Upon completion of the radiation, the package was opened to confirm that dry ice remained in the box. The samples were again sealed in the Styrofoam box so that the temperature rise would be gradual, allowing for crosslinks to continue to form unimpeded by the frozen antioxidant. The samples attained room temperature within 24 hours. This process provided UHMWPE specimens with various antioxidant concentrations that were irradiated below the melting temperature (solidification temperature) of the alpha-tocopherol.

### Example 3

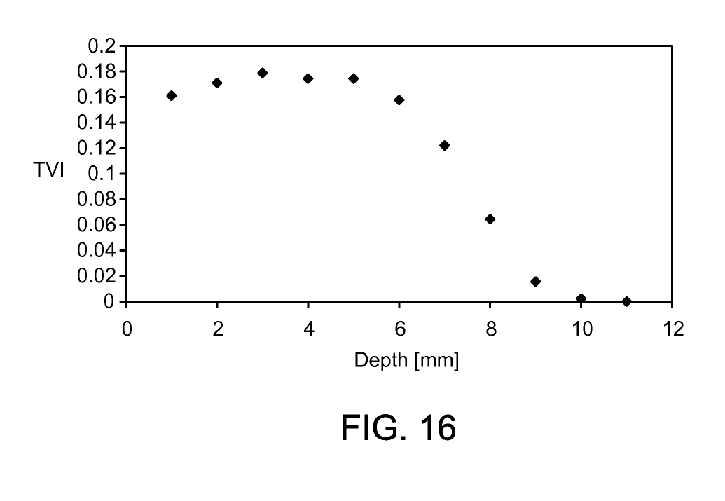

A 12 mm thick sheet of GUR 1020 medical grade ultra-high molecular weight polyethylene (UHMWPE) compression molded sheet containing 0.1% Vitamin E (alpha-tocopherol) was irradiated to a dose of 100 kGy using 2.8 MeV electron beam irradiation (Electron Technologies Inc, South Windsor, Conn.). Fourier Transform Infrared (FTIR) Spectroscopy was performed using a Nicolet Magna 860 spectrometer on thin sections of the irradiated sheet of 100 μm thickness, prepared using a Leitz Wetzlar (Leica Microsystems, Nussloch, Germany) sledge microtome. The sections were cut orthogonally to the surface of the sheet so that it was possible to collect spectra at various depths from the irradiated surface. Prior to measurement, the sections were smoothed using a 360 grade emery paper to decrease the likelihood of Fourier rippling to be observed in the spectra. An IR beam diameter of 100 μm was used to measure the IR spectra at 1 mm increments. The transvinylene index (TVI), defined as the ratio of the area of the 965 l/cm absorbance peak and the 1900 l/cm IR absorbance peak, is known to be directly proportional to the dose absorbed by the UHMWPE sheet (see, e.g., Muratoglu et al., Biomaterials 24 (2003): 2021-2029). Referring to FIG. 16, the TVI versus depth measurements showed that the absorbed radiation dose was non-uniform, and consequently, the crosslink density was also non-uniform over various depths in the sample containing a uniform concentration of Vitamin E. This treatment provided an article that was highly crosslinked up to a depth of 6 mm and then the crosslink density declined with absorbed dose. However, the uniform distribution of the antioxidant Vitamin E ensured that the entire article is oxidation-resistant. No thermal treatment was necessary to remove free radicals to make it oxidation-resistant, which would have been necessary in the absence of the antioxidant.

### Example 4

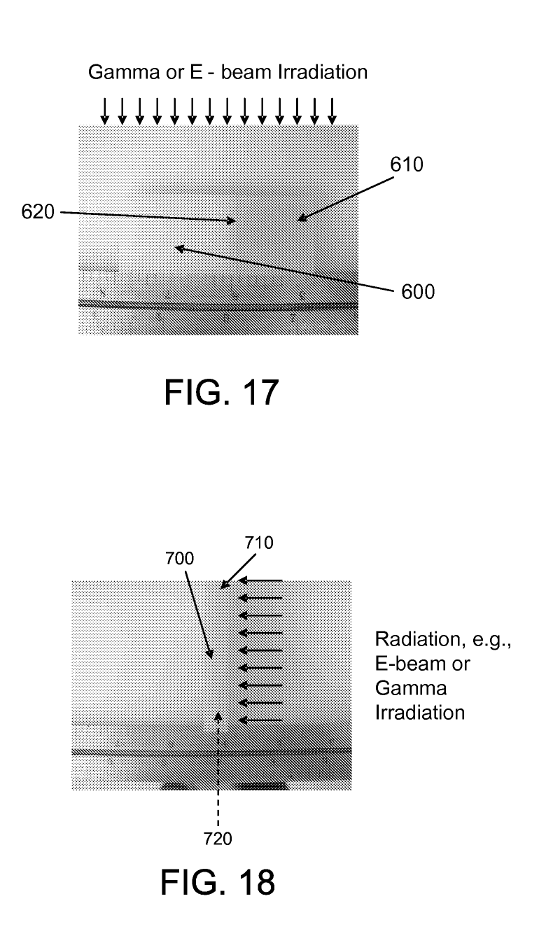

Referring to FIG. 17, a sheet 600 of GUR 1020 UHMWPE of 25.4 mm thickness without Vitamin E was fused with a sheet 610 GUR 1020 UHMWPE of 25.4 mm thickness containing 0.1% Vitamin E. Both sheets were placed on the lower platen of a Carver hydraulic press, pre-heated to 180° C. until approximately 1 mm thick surface layer of both sheets were melted. Then the two sheets were brought into contact and fused under a dead load. This ensured that the Vitamin E did not diffuse to a great extent into the UHMWPE which had no Vitamin E. An interface 620 is shown in FIG. 17. This fused sheet was then irradiated using gamma irradiation to a dose of 100 kGy. Gamma irradiation ensured that the delivered dose to both Vitamin E-rich and Vitamin E-poor UHMWPEs was essentially uniform. However, it has been shown (see, e.g., Oral et al., Biomaterials 26 (2005): 6657-6663) that the presence of 0.1% Vitamin E led to suppression of crosslinking by 16% when irradiated to a dose of 100 kGy. Therefore this article had uniform irradiation dose, non-uniform Vitamin E concentration and consequently non-uniform crosslinking. The direction of non-uniformity of crosslinking was controlled by the distribution of Vitamin E alone regardless of the direction of gamma radiation since gamma radiation fully penetrated the article. This article, or at least the portion that does not contain Vitamin E, can then be heat treated to decrease free radicals to make the article oxidation resistant.

### Example 5

The composite (Vitamin E-rich and Vitamin-E poor UHMWPE sandwich) article of Example 4 of 25.4 mm thickness was irradiated to 100 kGy using 2.8 MeV electron beam irradiation, which delivered a non-uniform dose to the article. As shown by FIG. 16, there is essentially no detectable radiation dose absorbed below a depth of 10 mm. A combination of non-uniform Vitamin E in the transverse direction with respect to the direction of irradiation and non-uniform dose absorbed along the direction of irradiation leads to non-uniform crosslinking in both the direction of irradiation as well as in the transverse direction.

### Example 6

A sheet 700 of GUR 1020 UHMWPE of 3 mm thickness without Vitamin E was fused with a sheet 710 of GUR 1020 UHMWPE of 2 mm thickness containing 0.1% Vitamin E, as shown in FIG. 18. Each sheet was placed on the lower platen of a Carver hydraulic press, pre-heated to 18° C. until approximately 1 mm thick surface layer of both sheets were melted. Then the two sheets were brought into contact and fused under a dead load. This ensured that the Vitamin E did not diffuse to a great extent into the UHMWPE, which had no Vitamin E, providing a sharp interface 720 between the Vitamin E-rich and Vitamin E-poor regions of the sheet. This fused sheet is then irradiated using gamma irradiation to a dose of 100 kGy. Gamma irradiation ensures that the delivered dose to both Vitamin E-rich and Vitamin E-poor UHMWPEs is essentially uniform. However, it has been shown (see e.g., Oral et al., supra) that the presence of 0.1% Vitamin E leads to suppression of crosslinking by 16% (175+/−19 mol/m³ for pure UHMWPE versus 146+/−4 mol/m³ for UHMWPE containing 0.1% Vitamin E) when irradiated to a dose of 100 kGy. Therefore this article had uniform irradiation dose, non-uniform Vitamin E concentration and consequently non-uniform crosslinking. The direction of non-uniformity of crosslinking was controlled by the distribution of Vitamin E alone regardless of the direction of gamma radiation since gamma radiation fully penetrated the article. This article, or at least the portion that does not contain Vitamin E, can then be heat treated to decrease free radicals to make the article oxidation resistant.

### Example 7

The 5 mm thick sheet of Vitamin E-rich and Vitamin E-poor of Example 4 is irradiated to 100 kGy using 2.8 MeV electron beam irradiation, which delivers a relatively uniform dose to the article over a 6 mm thickness. Therefore, this article, if irradiated using 2.8 MeV electrons in a direction orthogonal to the interface of the Vitamin E rich-Vitamin E poor regions, will, like Example 6, have non-uniform crosslinking solely due to non-uniform distribution of Vitamin E.

### Example 8

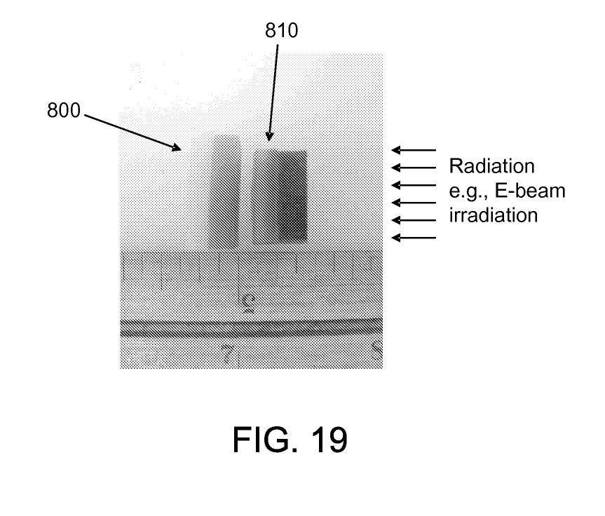

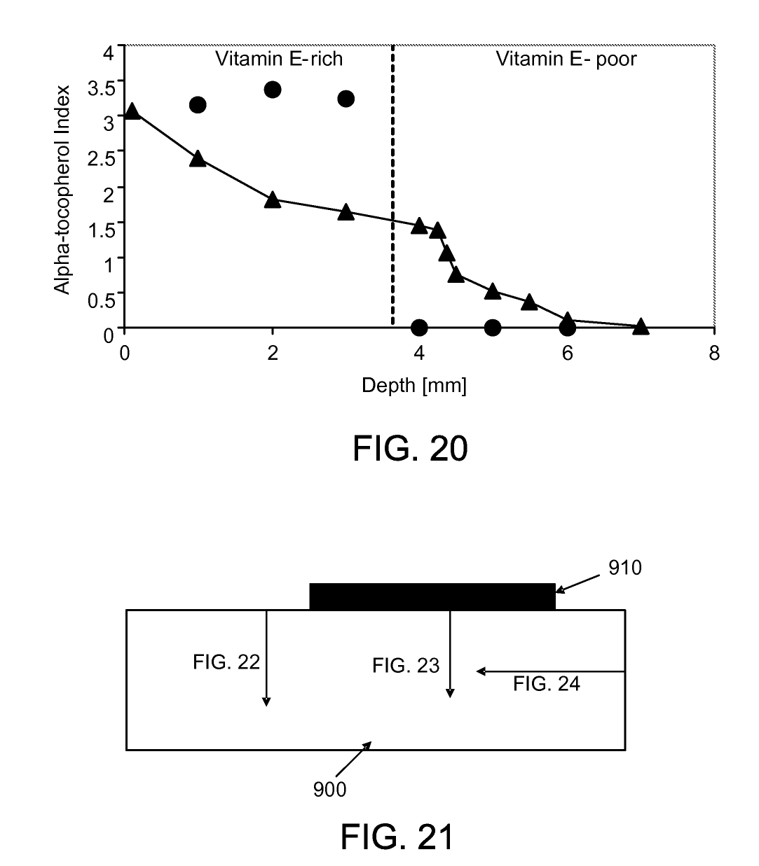

Alpha-tocopherol (synthetic Vitamin E) obtained from Sigma-Aldrich was dissolved into ethanol to form a 50:50 (v/v) solution. GUR 1050 UHMWPE (Ticona, Bayport, Tex.) powder was added to form a 10% by weight of alpha-tocopherol-UHMWPE blend having a large excess of alpha-tocopherol. The blend was heated to evaporate the ethanol and to coat the powder uniformly with alpha-tocopherol. The alpha-tocopherol coated UHMWPE was placed in a custom built mold with a plunger and placed in a Carver hydraulic press equipped with heating platens. The mold was heated to 190° C. and then a load applied (approximately 1 MPa pressure) to the powder to mold the melt into a bulk cylinder of 25.4 mm diameter and 25.4 mm height. The sample was isobarically, slow-cooled to room temperature and the load removed. The sample was machined into a sheet of 3.8 mm thickness. A GUR 1050 compression molded UHMWPE block containing no Vitamin E was machined into a sheet of 3.2 mm thickness. One surface of both the Vitamin E containing UHMWPE sheet and the pure UHMWPE sheet were heated to 18° C. until about 1 mm thick near-surface region melted. The two sheets were mated and a dead load was applied until the samples cooled to form a single-fused sheet of 7 mm thickness, as shown in FIG. 19 (left sample 800). The sheet with the top surface being the Vitamin E-rich UHMWPE was irradiated to a dose of 100 kGy using 2.8 MeV electron beam irradiation (Electron Technologies Inc, South Windsor, Conn.). One half of the sample was placed in a convection oven and annealed at 130° C. under nitrogen atmosphere for a period of 24 hours to allow diffusion of the excess Vitamin E in the Vitamin-E rich regions into the Vitamin E-poor regions. After annealing for a period of 24 hours, there was visible discoloration of the Vitamin E-poor regions of the sheet, indicating diffusion of Vitamin E into that region, as shown in FIG. 19, right sample 810. Fourier Transform Infrared (FTIR) Spectroscopy was performed using a Nicolet Magna 860 spectrometer on thin sections of the irradiated sheets of 100 μm thickness, prepared using a Leitz Wetzlar (Leica Microsystems, Nussloch, Germany) sledge microtome. Thin sections were cut orthogonally to the surface of the sheet so that it was possible to collect spectra at various depths from the irradiated surface. An IR beam diameter of 100 μm was used to measure the IR spectra at 1 mm increments. The Alpha-tocopherol index (TVI) defined as the ratio of the area of the 1276 l/cm absorbance peak associated with alpha-tocopherol and the 1900 l/cm IR skeletal polyethylene absorbance peak is known to be directly proportional to the concentration of alpha-tocopherol in the UHMWPE sheet (see, e.g., Oral et al., supra). FIG. 20 shows the alpha-tocopherol index before and after annealing at 130° C. for a period of 24 hours, indicating that these conditions led to diffusion of the alpha-tocopherol index into the Vitamin E-poor regions. The alpha-tocopherol index at 7 mm was 0.015. An alpha-tocopherol index of 0.012 corresponds to a concentration of 0.1%, which was sufficient to provide oxidation-resistance (see, e.g., Oral et al.). Therefore, the annealing was able to render the entire sheet oxidation resistant. In addition, Oral et al. shows that when alpha-tocopherol is present in UHMWPE in a 0%, 0.1% (alpha-tocopherol index of 0.012) and 0.3% (alpha tocopherol index of 0.03) concentration, the crosslink density upon irradiation to a dose of 100 kGy was 175+/−19 mol/m³, 146+/−4 mol/m³, 93+/− mol/m³, respectively. Therefore, 0.1% and 0.3% alpha-tocopherol suppressed crosslink density by 16% and 47% respectively. The Vitamin E-rich regions of the sheet had an alpha-tocopherol index of over 3.0, which was two orders of magnitude higher than the 0.3% concentration indicating that these regions should have low or no crosslinking, while the Vitamin E-poor regions containing no alpha-tocopherol during irradiation, were highly crosslinked by a dose of 100 kGy. Thus, this article had non-uniform Vitamin E, a non-uniform radiation dose since the dose profile shows a decrease at 6 mm (see FIG. 16) and a non-uniform crosslinking along the direction of irradiation. After annealing, the article is oxidation-resistant throughout the article due to alpha-tocopherol diffusion.

### Example 9

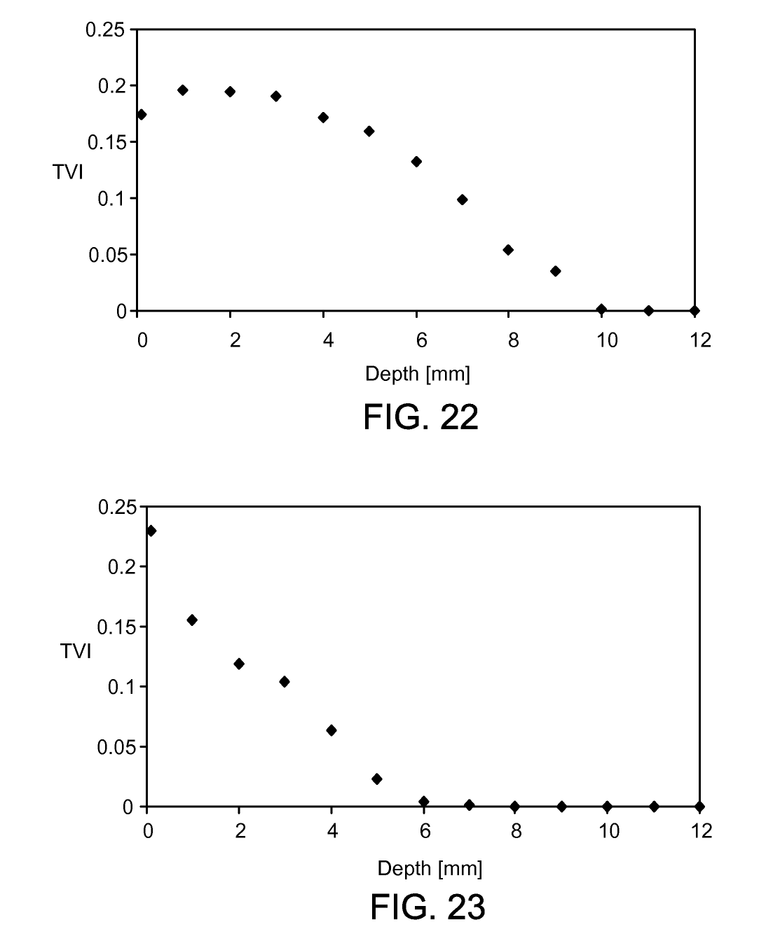

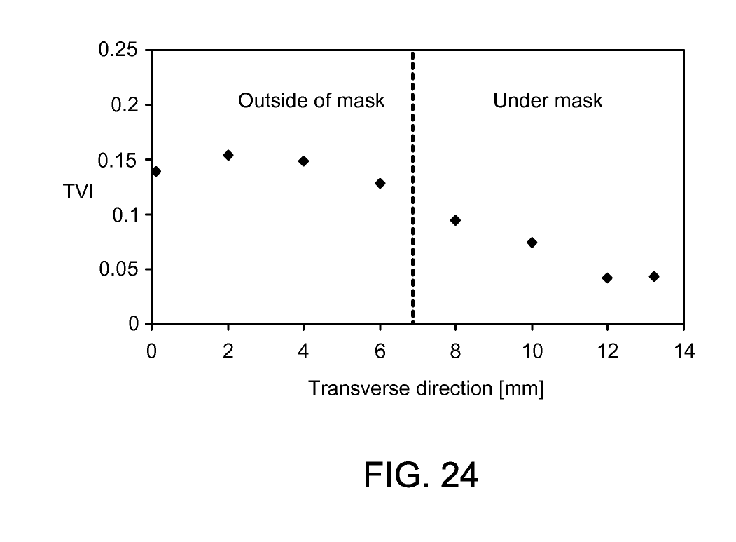

Referring to FIG. 21, a 12 mm thick sheet 900 of GUR 1020 medical grade ultra-high molecular weight polyethylene (UHMWPE) compression molded sheet containing 0.05% Vitamin E (alpha-tocopherol) was irradiated to a dose of 100 kGy using 2.8 MeV electron beam irradiation (Electron Technologies Inc, South Windsor, Conn.). Prior to submission for electron beam irradiation, a region of the surface was covered with a 1/16″ thick aluminum sheet 910 to alter the dose profile underneath the mask and to create non-uniformity in the dose delivered in a direction transverse to the direction of irradiation. Fourier Transform Infrared (FTIR) Spectroscopy was performed using a Nicolet Magna 860 spectrometer on thin sections of the irradiated sheet of 100 μm thickness, prepared using a Leitz Wetzlar (Leica Microsystems, Nussloch, Germany) sledge microtome. Thin sections were cut orthogonal to the surface of the sheet so that it was possible to collect spectra at various depths from the irradiated surface both outside and underneath the aluminum mask. FIG. 21 shows the directions along which spectral measurements were taken for each of FIGS. 22, 23, and 24. A scan was also performed in a transverse direction (orthogonal to the direction of radiation) at a depth of 6 mm from the irradiated surface to examine the non-uniformity of the delivered radiation dose for the regions outside the mask and the regions underneath the mask. Prior to measurement, the sections were smoothed using a 360-grade emery paper to decrease the likelihood of Fourier rippling in the spectra. An IR beam diameter of 100 μm was used to measure the IR spectra at 1 mm increments. The transvinylene index (TVI) defined as the ratio of the area of the 965 l/cm absorbance peak and the 1900 l/cm IR absorbance peak is known to be directly proportional to the dose absorbed by the UHMWPE sheet (see reference 1). FIG. 22 shows the TVI versus depth profile, showing that the absorbed radiation dose was non-uniform, and consequently, the crosslink density was also non-uniform over various depths in this UHMWPE sample containing a uniform concentration of Vitamin E. There was little measurable radiation dose beyond a depth of 10 mm. FIG. 23 shows that underneath the aluminum mask, there was an approximately linear decrease in radiation dose delivered. After a depth of 6 mm, there was almost no radiation dose absorbed. Referring to FIG. 24, a scan was performed from sample's edge and proceeded the mask at a subsurface depth of 6 mm. The scan showed that there was a gradual decrease in TVI or radiation dose along the transverse direction at a subsurface depth of 6 mm from the irradiation surface. The irradiation dose under the aluminum mask was lower then the irradiation dose at the same depth outside the mask, creating a non-uniform crosslinking in the transverse direction. Thus, this treatment provided an article that was non-uniformly crosslinked in both the direction of irradiation as well as the transverse direction, based on the non-uniformity associated with the low powered electron beam as well as the non-uniformity of delivered dose associated with the aluminum mask. This article was also oxidation resistant due to a uniform distribution of antioxidant Vitamin E throughout the article, and no thermal treatment was necessary after irradiation to remove free radicals to make it oxidation-resistant.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A polymeric preform comprising:
a first region comprising a first polymeric material having a first concentration of a first antioxidant dispersed therein;
a second region comprising a second polymeric material having a second concentration higher than the first concentration of a second antioxidant dispersed therein; and
an interface defined between by first and second regions.

2. The preform of claim 1, wherein the first polymeric material, the second polymeric material, or both, comprises a substantially non-crosslinked polymeric material.

3. (canceled)

4. The preform of claim 1, wherein the first polymeric material, the second polymeric material, or both, comprises a crosslinked material.

5. (canceled)

6. The preform of claim 1, wherein the first and second polymeric materials are the same polymeric material.

7. The preform of claim 1, wherein the first and the second polymeric materials are each a polyolefin.

8. The preform of claim 1, wherein the first or the second antioxidants, or both, comprises:
a phenolic compound, alpha-tocopherol, DL-alpha-tocopheryl acetate, (+)-alpha-tocopherol acid succinate, or delta-tocopherol; propyl, octyl, or dodecyl gallates; lactic, citric, or tartaric acids and salts thereof; orthophosphates, tertiary-butylhydroquinone (TBHQ), butylated hydroxyanisole (BHA), or butylated hydroxytoluene (BHT), or mixtures thereof.

9. The preform of claim 1, wherein the first and/or second antioxidants comprise between about 0.01 percent by weight to about 20 percent by weight of their respective regions.

10. The preform of claim 1, wherein the first concentration is zero.

11. A polymeric preform comprising:
a first crosslinked region comprising a first crosslinked polymeric material having a first average crosslink density;
a second crosslinked region comprising a second crosslinked polymeric material having a second average crosslink density higher than the first average crosslink density; and
an interface defined between the first and second regions.

12. The preform of claim 11, wherein the polymeric preform further comprises one or more antioxidants uniformly dispersed therein.

13. The preform of claim 11, wherein the polymeric preform is substantially free of antioxidants.

14. The preform of claim 11, wherein the interface is (a) a sharp interface, wherein a transition from the first average crosslink density to the second average crosslink density occurs within a distance of about 0.05 mm or less, or (b) a diffuse interface, wherein a transition from the first density to the second density occurs within a distance of about 1 mm or less.

15. The preform of claim 11, wherein the first and the second polymeric materials are each a polyolefin.

16. The preform of claim 11, wherein the first crosslinked polymeric material comprises an ultra-high molecular weight polyethylene (UHMWPE) having a crosslink density of greater than about 50 mol/m³.

17. The preform of claim 11, wherein the second polymeric material comprises an ultra-high molecular weight polyethylene (UHMWPE) having a molecular weight between crosslinks of less than about 9,000 g/mol.

18-31. (canceled)

32. A method of making a preform, the method comprising:
combining a first substantially non-crosslinked polymeric material with a first antioxidant to provide a first molding compound having a first concentration of the first antioxidant in the first molding compound;
combining a second substantially non-crosslinked polymeric material with a second antioxidant to provide a second molding compound having a second concentration of the second antioxidant higher than the first antioxidant in the first molding compound;
combining the first molding compound and the second molding compound to provide a composite molding compound; and
molding the composite molding compound in a desired shape to provide a composite preform.

33. The method of claim 32, further comprising irradiating the preform.

34. The method of claim 32, further comprising annealing the preform.

35-46. (canceled)

47. A method of making a composite preform, the method comprising:
combining a first substantially non-crosslinked polymeric material with a first antioxidant to provide a first molding compound;
combining a second substantially non-crosslinked polymeric material with a second antioxidant to provide a second molding compound;
combining the first molding compound and the second molding compound to provide a composite molding compound; and
molding the composite molding compound in a desired shape to provide a composite preform.

48. The method of claim 47, wherein the first and second antioxidants are uniformly distributed within the first and second molding compounds.

49-51. (canceled)

52. The method of claim 47, further comprising crosslinking the molding compounds by irradiating the composite molding compound with an ionizing radiation comprising gamma radiation or a low-powered electron beam radiation, to provide a crosslinked composite.

53-58. (canceled)

59. The preform of claim 7, wherein the polyolefin is a ultra-high molecular weight polyethylene (UHMWPE).
